(19) United States
(12) Patent Application Publication
(10) Pub. No.: US 2012/0209735 A1
(43) Pub. Date: Aug. 16, 2012

(54) FEDERATED THIRD-PARTY AUTHENTICATION APPARATUSES, METHODS AND SYSTEMS

(76) Inventors: Peruvemba Subramanian, Santa Clara, CA (US); Mark Rose, San Jose, CA (US); Lex N. Bayer, Menlo Park, CA (US)

(21) Appl. No.: 13/278,103

(22) Filed: Oct. 20, 2011

Related U.S. Application Data
(60) Provisional application No. 61/455,384, filed on Oct. 20, 2010.
(60) Provisional application No. 61/467,772, filed on Mar. 25, 2011.

(51) Int. Cl. G06Q 30/00; G06F 15/16; G06F 21/20

(52) U.S. Cl. 705/26.1; 726/3

(57) ABSTRACT

The FEDERATED THIRD-PARTY AUTHENTICATION APPARATUSES, METHODS AND SYSTEMS (“FPT”) transform user identity information inputs associated with transactions at a merchant server into a user-profile output that is transferred to other merchant websites for facilitating one or more other transactions without the requisite need for full user re-entry of information. In one embodiment, the method includes establishing a first trust indication associated with a first merchant and receiving first user-transaction-related information from a server of the first merchant. A first user-profile is generated for the user based on the first user-transaction-related information. A second trust indication associated with a second merchant is established. The first user-profile is then sent to the second merchant based on the established first and second trust indications, whereby the first user-profile provides the first user-transaction-related information for facilitating transactions by the user at a server of the second merchant.

This patent application disclosure document (hereinafter “description” and/or “descriptions”) describes inventive aspects directed at various novel innovations (hereinafter “innovation,” “innovations,” and/or “innovation(s)”) and contains material that is subject to copyright, mask work, and/or other intellectual property protection. The respective owners of such intellectual property have no objection to the facsimile reproduction of the patent disclosure document by anyone as it appears in published Patent Office file/records, but otherwise reserve all rights.

### PRIORITY CLAIM

Applicant hereby claims priority under 35 USC §119 from U.S. provisional patent application Ser. No. 61/455,384, filed Oct. 20, 2010, entitled “User profile authentication for third-party payment processors through the use of federated profiles across multiple online merchants,” and provisional patent application Ser. No. 61/467,772, filed Mar. 25, 2011, entitled “Apparatuses, Methods and Systems For Federated Internet Website Enrollment,” attorney docket no. P-40432PRV|20270-101PV. The entire contents of the aforementioned applications are herein expressly incorporated by reference.

### FIELD

The present invention is directed generally to apparatuses, methods, and systems for user authentication, and more particularly, to FEDERATED THIRD-PARTY AUTHENTICATION APPARATUSES, METHODS AND SYSTEMS.

### BACKGROUND

Systems exist allowing users or consumers to use their computer devices (e.g., smart phones, tablets, laptop computers, desktop computers, PDAs, etc.) to log onto various on-line sites (e.g., bank accounts, merchants, etc.). In order for the user to utilize such on-line sites, there may be a requirement for satisfying various authentication criteria.

### BRIEF DESCRIPTION OF THE DRAWINGS

The accompanying appendices and/or drawings illustrate various non-limiting, example, inventive aspects in accordance with the present disclosure:

FIG. 1 is of a block diagram illustrating example aspects of providing user-access to multiple websites via profile transfers in some embodiments of the FPT;

FIG. 1A is of a block diagram illustrating example aspects of elements of a system in some embodiments of the FPT;

FIG. 1B is of a block diagram illustrating example aspects of the shadow account creation of a user's profile in some embodiments of the FPT;

FIG. 2A is of a block diagram illustrating example aspects of a profile creation process in some embodiments of the FPT;

FIG. 2B is of a block diagram illustrating example aspects of a profile access process in some embodiments of the FPT;

FIG. 2C is of a block diagram illustrating example aspects of a profile merging process in some embodiments of the FPT;

FIG. 3 is of a logic flow diagram illustrating a profile creation, matching, and merging process in some embodiments of the FPT;

FIG. 4 is of a logic flow diagram illustrating a matching criteria process corresponding to the profile creation, matching, and merging process in some embodiments of the FPT;

FIG. 5 is of a logic flow diagram illustrating a profile access process in some embodiments of the FPT;

FIG. 6 is of a logic flow diagram illustrating another profile access process in some embodiments of the FPT;

FIG. 7 is of a block diagram illustrating example aspects of providing user access to a secure website in some embodiments of an FIE;

FIG. 8 is a block diagram further illustrating example aspects of providing user access to a secure website in some embodiments of the FIE;

FIG. 9 is of a block diagram further illustrating example aspects of providing user access to a secure website in some embodiments of the FIE;

FIG. 10 is a pop-up window provided by a transaction handler in some embodiments of the FIE;

FIG. 11 is of a block diagram illustrating example aspects of a secure website access process in some embodiments of the FIE;

FIG. 12 is of a block diagram illustrating embodiments of the FPT/FIE controller.

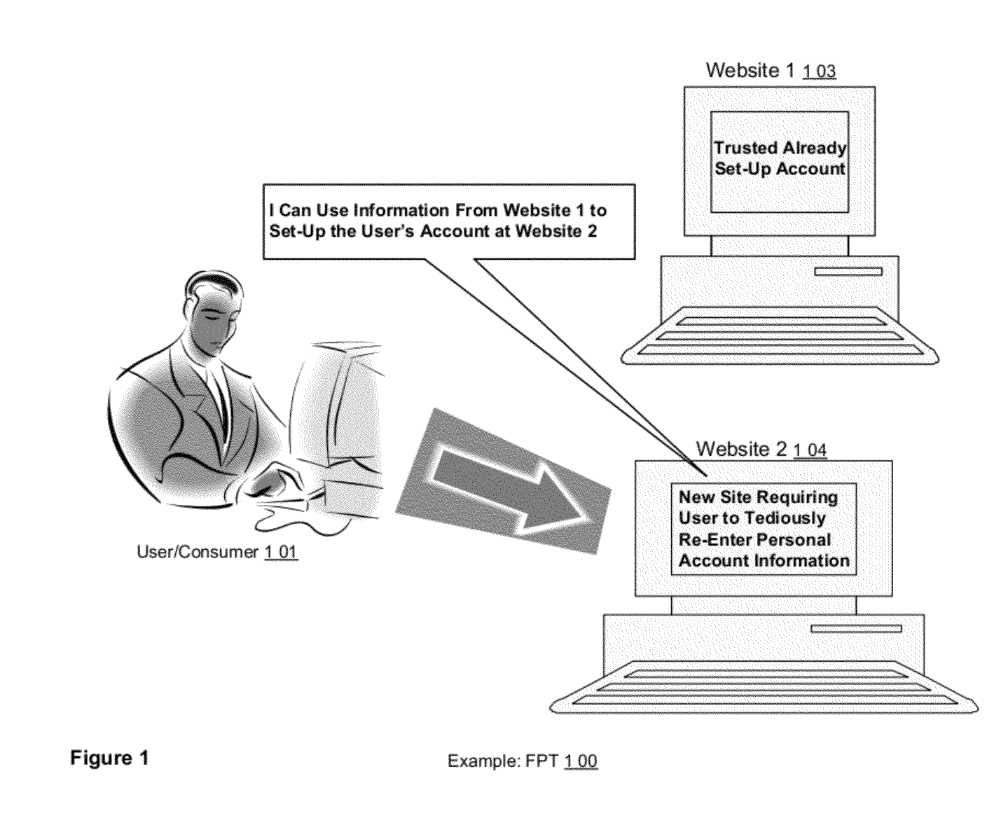

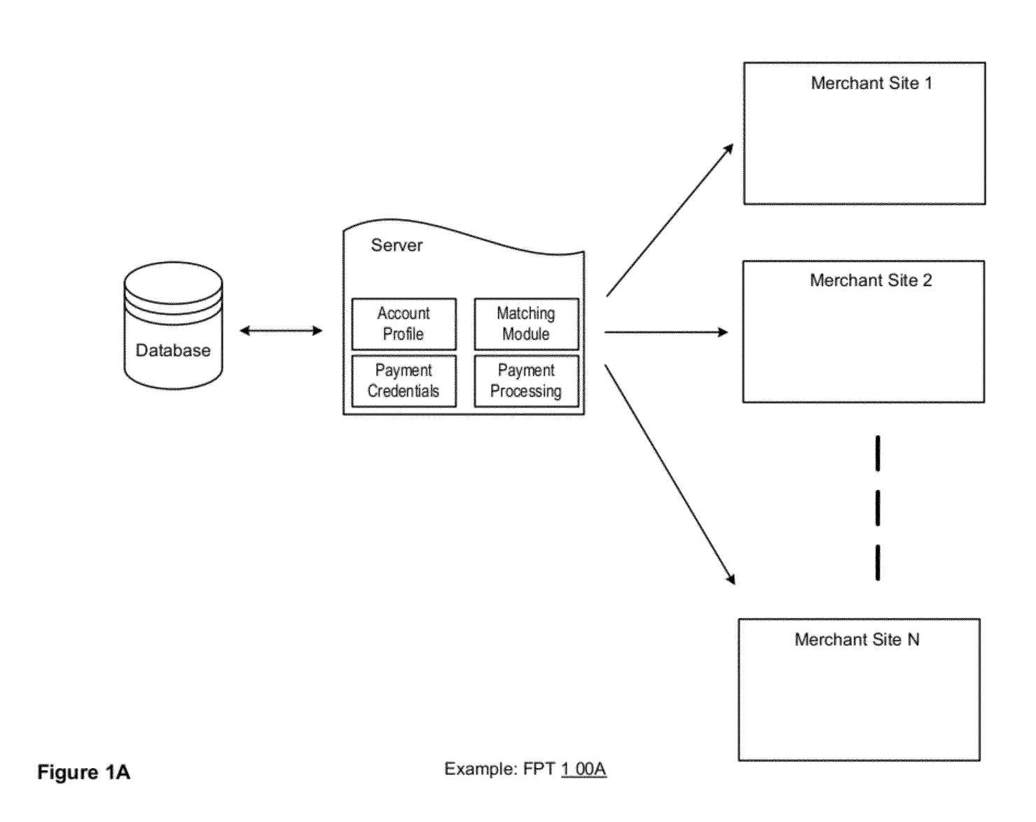

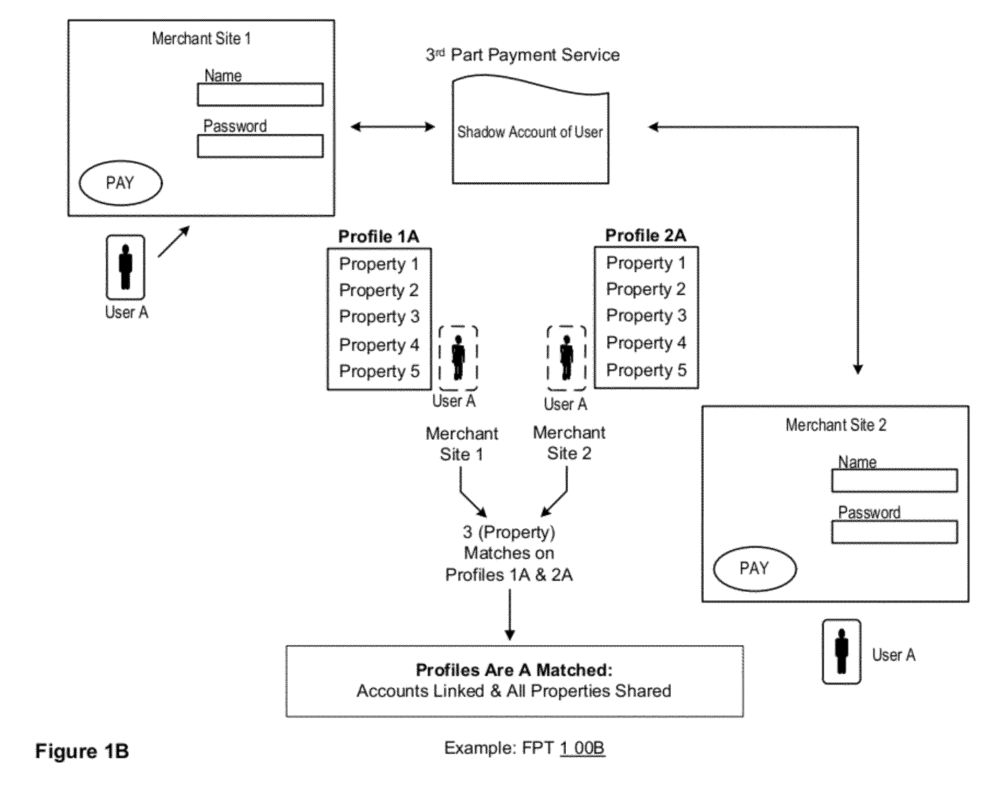

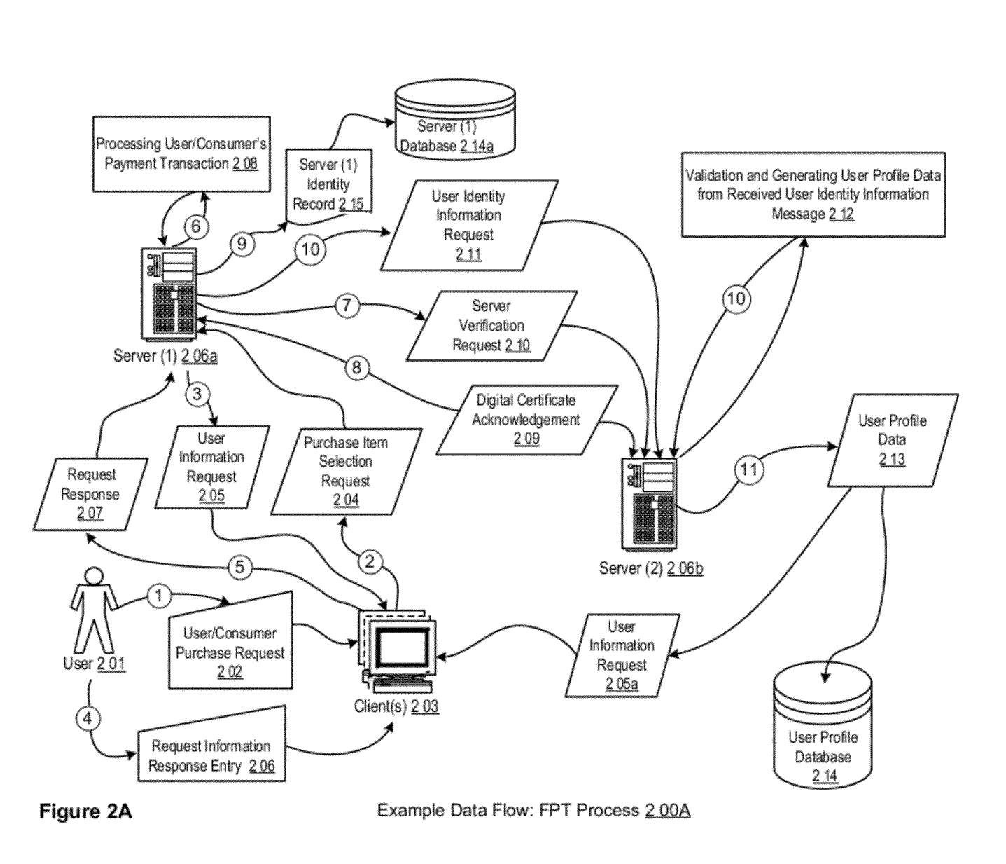

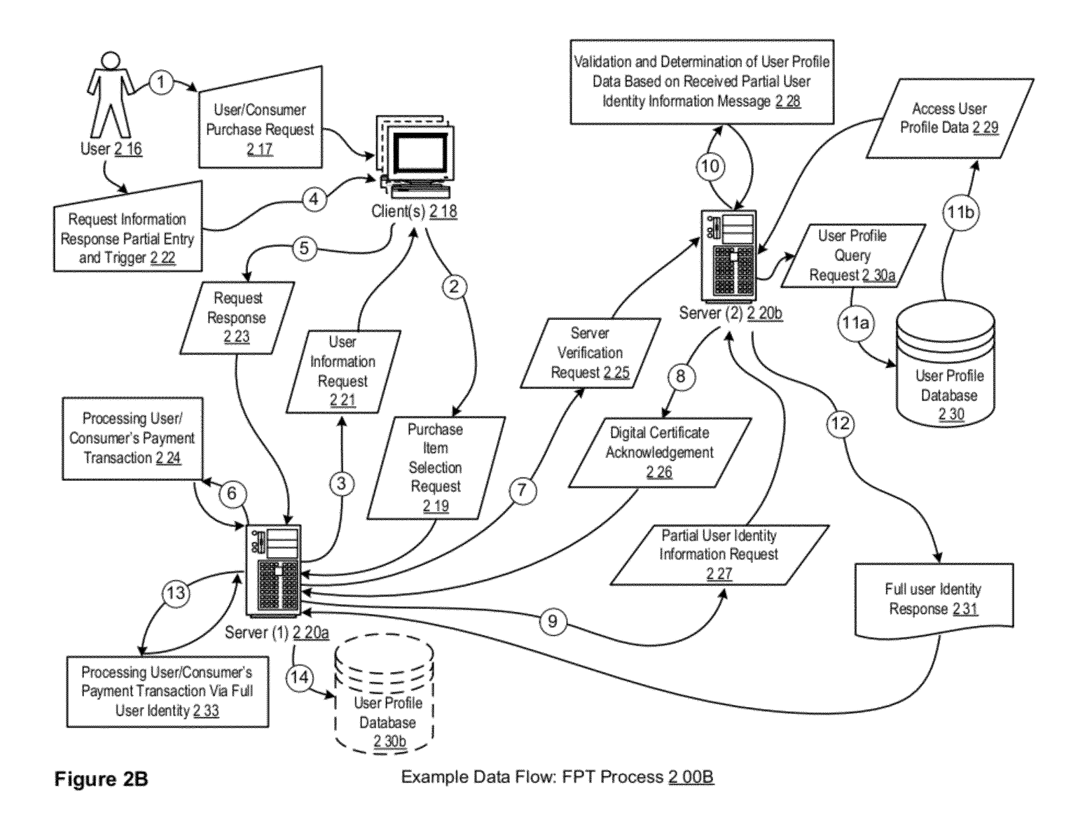

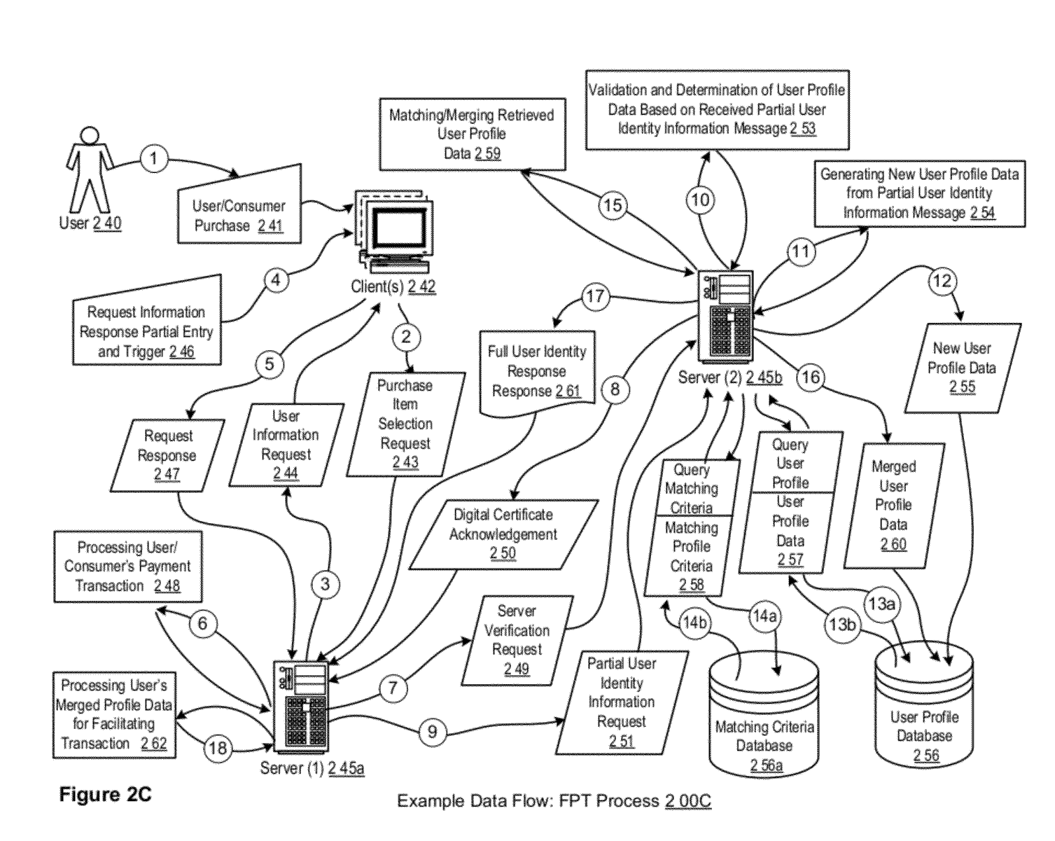

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

The FPT provides for the generation of user-profile information by an entity such as a payment processor (e.g., VISA) based on a user or consumer engaging in one or more online transaction with a trusted merchant. The payment processor (e.g., VISA) may transfer the generated user-profile information to other merchants or entities that are trusted by the payment processor. Thus, the need for re-entry of registration information at the other merchants or entities may be avoided based on information present in the transferred user-profile.

### FPT

The FEDERATED THIRD-PARTY AUTHENTICATION APPARATUSES, METHODS AND SYSTEMS (hereinafter “FPT system”) establish a user profile (e.g., a file or document including user-authentication and transaction-related data) that may be transferred to one or more other entities' (e.g., merchants) servers (e.g., hosting websites and/or executing mobile applications) for the purpose of the one or more other entities utilizing the information corresponding to the transferred user profile during transactions.

FIG. 1 is of a block diagram 100 illustrating example aspects of providing user-access to multiple websites via profile transfers in some embodiments of the FPT system. A user or consumer 101 may access and engage in a transaction with a trusted merchant website 103, where the user 101 already has account/payment information (e.g., credit card information) set-up. However, the user or consumer 101 may access and engage in a transaction with another merchant website 104, where the user 101 may be required to tediously re-enter all their account/payment information (e.g., credit card information). Instead of the user or consumer 101 being required to re-enter account/payment information at this other merchant website 104 during a transaction, the account/payment information (e.g., credit card information) may be transferred from the trusted merchant website 103 to the other merchant website 104.

Referring to FIGS. 1A and 1B, personalized profiles for third party payment services may require registration of the user as a first step. This registration step may reduce the effectiveness of the payment service in getting a user to complete a payment purchase. An example of such a payment service is PayPal (www.PayPal.com), where a user or consumer who is transacting on a merchant site is always require to be redirected to the PayPal website and required to login in order to gain access to the users account details and payment credential information to use as a payment for the merchants goods. This experience may not be user friendly since it requires the user to perform multiple steps in order to complete a transaction. Most sites require users to register to create a personalized payment profile for the user. The registration serves as a handle so that the user can identify themselves to retrieve their personalize profile. Most websites require users to register to create a personalized profile for the use of that site. The registration serves as a handle so that user can identify themselves to retrieve their personalize profile. Users who then make a purchase through a payment service must login or register for a second time creating friction and confusion in the purchasing experience. There exists a need, among other things, to improve the purchasing experience for users by, for example, eliminating the need to double login in order to make a purchase with a third party payment provider when purchasing goods from a merchant's site. The invention allows payment providers to utilize federated merchant login credentials to authenticate users making transactions on a merchant's site and transfer profile information, and payment information collected from other websites or interactions of the user to the payment flow of the merchant.

The illustrated and described implementation of the FPT system allows a payment provider to create a payment profile that federates with the profile of the user on a third party merchant site. This implementation may not require the user to explicitly create a profile (registration) for personalized rendition of services. This implementation may also not require the use of cookies or other explicit authentication techniques to create a profile. Rather, the implementation here combines the user task of making a payment to the merchant using a third party payment widget/application with the fact that the user is signed in on the merchant site already to create a personalized profile for the user. The payment provider then makes this profile accessible to the user anytime the user traverses the same path of launching the widget/application on that merchant's website. In this implementation, the merchant using the Payment service provider signs any transaction data along with a unique user handle for the user. The user handle is obtained and validated by the merchant by standard login methods. This validated user handle, along with the payment instrument submitted by the user allow the service provider to create a unique profile that can be used for personalization services. This hidden/shadow profile can then be claimed by the user with proper identification in the future. The payment processor can extend the profile to the same user on a different merchant's website once that user is authenticated (logged-in) on the second merchant's site and shares a common profile field such as email or payment credential (e.g., credit card).

As illustrated in FIGS. 1A-1B, the system consists of hardware, software and communication protocols that collectively perform the requirements of the system. One such implementation option would be as follows. A central server (e.g., a payment processor server) runs software to manage a database and store account and profile information associated with users transactions. When the server detects a match in profile information, it links the user's merchant profiles together to form a unified (i.e., merged) profile (account) for the user which can then be extended to the user the next time the user makes a transaction.

FIG. 2A is of a block diagram 200A illustrating example aspects of a profile generation process in some embodiments of the FPT. A user or consumer 201 may desire to make a user/consumer purchase 202 by accessing and browsing web pages that are generated by a merchant server system 206a via a client device 203. In some example aspect, the client device 203 may be a user or consumer's 201 web-enable computer (e.g., laptop, desktop, tablet, etc.) or a mobile communication device (e.g., PDA, smartphone, etc.).

For example, during the browsing process, the user 201 may activate a hyperlink associated with purchasing a desired sale item (e.g., iPad) causing the client device 203 to generate a purchase item selection request 204 for processing by the merchant server 206a. In response to the purchase item selection request 204, the server 206a generates a user information request page 205 for facilitating the entry of transaction-related information by the user or consumer 201. Thus, the user 201 may enter transaction-related information 206 such as, for example, a user's name, the user's residential address, the user's billing address, the user's Email address(es), the user's credit card information, the user's username at merchant website, and user's password information at the merchant website. The entered requested information 206 is then sent via the client device 203 to the server 206a as a request response 207. The server 206a processes 208 the received request response 207 by packaging the transaction-related information for transmission to a server system 206b of a payment processor (e.g., VISA).

In some implementations, in response to the purchase item selection request 204, a payment processor server 206b may execute a payment transaction widget and generate (e.g., via a javascript or AJAX lightbox) a user information request page 205a for facilitating the entry of transaction-related information by the user or consumer 201 at the merchant server 206a. Such an implementation also applies in response to purchase item selection requests 219 and 243 of FIGS. 2B and 2C, respectively.

For example, the payment processor server may generate a code listing similar to the example code listing provided below as the payment transaction widget:

| <html> | |
|---|---|
| <body> | |
| <script type=“text/javascript” src=“http://static.pay.com/js/ | |
| ultimatepay-api.js”></script> | |
| <script type=“text/javascript”> | |
| var ultimatePayParams = { | |
| “sn” | : “ACME”, |
| “userid” | : “131827”, |
| “currency” | : “USD”, |
| “sepamount” | : “6.99”, |
| “amountdesc” | : “Gold Membership”, |
| “hash” | : “df659d502af5151a2edd18e2ebb50ba3”, |
| “xdurl” | : “http://www.mydomain.com/xd.html” |

```
    }
    // Merchant-defined function to display Lightbox.
    function showLightbox( ) {
        ulp.ultimatePay = true;
    ulp.displayUltimatePay( );
    }
    </script>
    <a href=“javascript:showLightbox( );”>Pay Now</a>
    <div id=“div_b” style=
“display:none;padding:10px;position:absolute;top: 50%;left: 50%;
margin-top: −212px; margin-left: −351px;”></div>
  </body>
</html>
```

The above-described FPT process may generate a request for user information data, e.g., 207, whereby, for example, the server, e.g., 206a, may receive a HTTP(S) POST request similar to the example below:

```
POST /requestuserinformation.php HTTP/1.1
Host: www.FPTprocess.com
Content-Type: Application/XML
Content-Length: 788
<?XML version = “1.0” encoding = “UTF-8”?>
<user_information_request>
        <timestamp>2011-02-22 17:00:01</timestamp>
        <user_account_params>
            <user_account_ID>1234567JS</ user_account_ID>
            <account_name>John Smith</account_name>
            <account_type>credit</account_type>
            <account_num>123455789012345</account_num>
            <account_expiry>01/01/2014</account_expiry>
        </user_account_params>
        <user_billing_information>
            <user_billing_address>3 Street Lane, New York, NY,
            10001, United States </user_billing_address>
            <user_telephone_number>01012345
            </user_telephone_number>
            <user_email_1>test@gmail.com</user_email_1>
            <user_email_2>test@hotmail.com</user_email_2>
            <user_residential_address>3 Street Lane, New York, NY,
            10001, United States</user_{—} residential_address>
        </user_billing_information>
        <purchase_summary>
            <num_products>1</num_products>
            <purchased_item>iPad tablet computer</purchased_item>
            <purchase_price>$560</purchase_price>
        </purchase_summary>
        <user_login>
            <user_name>jdoe</user_name>
            <user_password>jdoe1234abcde</user_password>
        </user_login>
</user_information_request>
```

However, prior to the transaction-related information being sent to the payment processor server system 206b by the merchant server 206a, the payment processor server system 206b identifies the merchant server 206a as a trusted website. Therefore, the merchant server 206a sends a server verification request 210 to the payment processor server system 206b, whereby the server verification request may for example, include a digital certificate. Once the payment processor server system 206b processes the received digital certificate, it may then determine that the merchant is a trusted website.

The above-described FPT process may generate a server verification request, e.g., 210, whereby, for example, the server, e.g., 206b, may receive a HTTP(S) POST request similar to the example below:

```
POST /verificationrequest.php HTTP/1.1
Host: www.FPTprocess.com
Content-Type: Application/XML
Content-Length: 788
<?XML version = “1.0” encoding = “UTF-8”?>
<authentication_information>
        <digital_certificates>
            <num_certificates>3</num_certificates>
            <certificate1>public_key_certificate_1 </certificate1>
            <certificate1>public_key_certificate_2 </certificate1>
            <certificate1>public_key_certificate_3 </certificate1>
        </digital_certificates>
        <encryption>
            <hash1>hash_function_1</hash1>
            <hash2>hash_function_2</hash2>
        </encryption>
</authentication_information>
```

Upon a successful authentication of the merchant via the exchanged digital certificate, the merchant server 206a subsequently transmits the packaged transaction-related information to the payment processor server system 206b as a user identity information request 211. In addition, the packaged transaction-related information may be stored as a server identity record in the merchant server's 206a database 214a. The user identity information request 211 may include a payment processor assigned merchant identifier (e.g., a user account ID), a payment processor assigned merchant password (e.g., a partner code assigned by the payment processor), and the transaction-related information.

The above-described FPT process may generate a user identity information request, e.g., 211, whereby, for example, the server, e.g., 206b, may receive a HTTP(S) POST message similar to the example below:

```
POST /useridentityinformation.php HTTP/1.1
Host: www.FPTprocess.com
Content-Type: Application/XML
Content-Length: 788
<?XML version = “1.0” encoding = “UTF-8”?>
<user_identity_information>
    <transaction_related_information>
      <timestamp>2011-02-22 17:00:01</timestamp>
      <user_account_params>
        <user_account_ID>1234567JS</ user_account_ID>
        <account_name>John Smith</account_name>
        <account_type>credit</account_type>
        <account_num>123455789012345</account_num>
        <account_expiry>01/01/2014</account_expiry>
      </user_account_params>
      <user_billing_information>
        <user_billing_address>3 Street Lane, New York, NY,
        10001, United States </user_billing_address>
        <user_telephone_number>01012345
        </user_telephone_number>
        <user_email_1>test@gmail.com</user_email_1>
        <user_email_2>test@hotmail.com</user_email_2>
        <user_residential_address>3 Street Lane, New York, NY,
        10001, United States</user_{—} residential_address>
      </user_billing_information>
      <merchant_params>
        <merchant_id>3FBCR4INC</merchant_id>
        <merchant_name>Apple Store</merchant_name>
        <merchant_Industry>electronic goods</merchant_industry>
        <merchant_Location>Manhattan 10022</merchant_Location>
        <purchase_price>$599</purchase_price>
        <merchant_webaddress>www.applestore.com
        </merchant_webaddress>
      </merchant_params>
      <user_information>
        <date_of_birth>11/11/74</date_of_birth>
        <SSN>xxx_xx_xxxx</SSN>
        <gender>M</gender>
        <mobile_tel_number>917777745</mobile_tel_number>
      </user_information>
      <purchase_summary>
        <num_products>1</num_products>
        <purchased_item>iPad tablet computer</purchased_item>
        <purchase_price>$560</purchase_price>
      </purchase_summary>
      <user_login>
        <user_name>jdoe</user_name>
        <user_password>jdoe1234abcde</user_password>
        <hint_question>what color?< </hint_question>
        <hint_answer>black</hint_answer>
        <optional_biometric_code>8941</optional_biometric_code>
      </user_login>
    </transaction_related_information>
    <merchant_validation>
      <user_account_ID>12467JK</user_account_ID>
      <merchant_identifier>mm01111456asdrt</merchant_identifier>
      <merchant_secure_password>mm611asdrt
      </merchant_secure_password>
    </merchant_validation>
</user_identity_information>
```

In an alternative implementation, the exchange of a digital certificate may not be necessary. For example, the payment processor server system 206b may provide the merchant server 206a with a hash function for encrypting/decrypting any information (e.g., packaged transaction-related information) that is exchanged between the merchant server 206a and the payment processor server 206b. The same alternative implementation applies to FIGS. 2B and 2C described below.

The payment processor server system 206b processes the received user identity information request 211 by validating and generating user profile data from the received user identity information message 212. For example, the merchant may be further validated by processing the merchant identifier and merchant password that is received from the merchant server 206a at the payment processor server system 206b. Once there is validation of the merchant-generated user identity information, the information associated with the transaction-related information is utilized to generate a user-profile 212. The generated user-profile is then transferred to a user-profile database 214 via a user profile message 213.

The above-described FPT process may generate a user-profile message, e.g., 212, whereby, for example, the server, e.g., 206b, may send a HTTP(S) POST message similar to the example below:

```
POST /userprofilemessage.php HTTP/1.1
Host: www.FPTprocess.com
Content-Type: Application/XML
Content-Length: 788
<?XML version = “1.0” encoding = “UTF-8”?>
<user_profile_information>
  <transaction_related_information>
    <timestamp>2011-02-22 17:00:01</timestamp>
    <user_account_params>
      <user_account_ID>1234567JS</ user_account_ID>
      <account_name>John Smith</account_name>
      <account_type>credit</account_type>
      <account_num>123455789012345</account_num>
      <account_expiry>01/01/2014</account_expiry>
    </user_account_params>
    <user_billing_information>
      <user_billing_address>3 Street Lane, New York, NY,
      10001, United States </user_billing_address>
      <user_telephone_number>01012345</user_telephone_number>
      <user_email_1>test@gmail.com</user_email_1>
      <user_email_2>test@hotmail.com</user_email_2>
      <user_residential_address>3 Street Lane, New York, NY,
      10001, United States</user_{—} residential_address>
    </user_billing_information>
    <merchant_params>
      <merchant_id>3FBCR4INC</merchant_id>
      <merchant_name>Apple Store</merchant_name>
      <merchant_Industry>electronic goods</merchant_industry>
      <merchant_Location>Manhattan 10022</merchant_Location>
      <purchase_price>$599</purchase_price>
      <merchant_webaddress>www.applestore.com
      </merchant_webaddress>
    </merchant_params>
    <user_information>
      <date_of_birth>11/11/74</date_of_birth>
      <SSN>xxx_xx_xxxx</SSN>
      <gender>M</gender>
      <mobile_tel_number>917777745</mobile_tel_number>
    </user_information>
    <user_login>
      <user_name>jdoe</user_name>
      <user_password>jdoe1234abcde</user_password>
      <hint_question>what color?< </hint_question>
      <hint_answer>black</hint_answer>
      <optional_biometric_code>8941</optional_biometric_code>
    </user_login>
  </transaction_related_information>
  <merchant_validation>
    <merchant_identifier>mm01111456asdrt</merchant_identifier>
    <merchant_secure_password>mm611asdrt
    </merchant_secure_password>
  </merchant_validation>
  <user_matching_criteria>
    <criteria_number>4</criteria_number>
    <criteria_1>email_match</criteria_1>
    <criteria_2>account_name</criteria_2>
    <criteria_3>account_number</criteria_3>
    <criteria_4>user_password</criteria_4>
  </user_matching_criteria>
</user_profile_information>
```

The client device 203 facilitates the user or consumer's web browsing and transmits transaction-related information (e.g., name, billing address, credit card information, etc.) to the server system 204 by, for example, enabling the user or consumer 201 to fill-in one or more requisite fields in an online-purchase form (e.g., HTML generated form) generated and displayed to the user or consumer 210 by the server 206 during a online purchase transaction (e.g., buying shoes, shirts, etc.). At the merchant's server system 206, the user or consumer's 201 entered and verified transaction-related information (e.g., name, billing address, credit card information, etc.) is processed 204 in order to complete the transaction. During the transaction process, the transaction-related information (e.g., name, billing address, credit card information, etc.) and user-verification information (e.g., user-name, user-password, security question(s), user-biometric data, client device identifier code(s), etc.) are sent from the merchant server 204 to a payment processor server system 207 for processing. At the payment processor server 206, the transaction-related information and user-verification information are validated.

FIG. 2B is of a block diagram 200B illustrating example aspects of a profile access process in some embodiments of the FPT. The user or consumer 216 may desire to make a user/consumer purchase 216 by accessing and browsing web pages that are generated by a merchant server system 220a via a client device 218. In some example aspect, the client device 218 may be a user or consumer's 216 web-enable computer (e.g., laptop, desktop, tablet, etc.) or a mobile communication device (e.g., PDA, smartphone, etc.).

For example, during the browsing process, the user 216 may activate a hyperlink associated with purchasing a desired sale item (e.g., iPad) causing the client device 218 to generate a purchase item selection request 219 for processing by the merchant server 220a. In response to the purchase item selection request 219, the server 220a generates a user information request page 221 for facilitating the entry of transaction-related information by the user or consumer 216. Thus, the user 216 may enter partial transaction-related information 222 such as, for example, one or more of the user's name, the user's residential address, the user's billing address, the user's Email address(es), the user's credit card information, the user's username at merchant website, and user's password information at the merchant website.

An triggered data-transfer application executing on the merchant server 220a, or alternatively, remotely on the payment processor server 220b may detect and trigger a response to the user 216 that adequate information has been entered. For example in one implementation, once the requisite number of information fields in an XML form displayed to the user 216 have been filled, a radio button (e.g., “GET PROFILE” button) may flash on the user's 216 browser. Once the button is activated by the user 216, the partially entered requested information 222 is then sent via the client device 218 to the server 220a as a request response 223. The server 220a processes 224 the received request response 223 by packaging the partial transaction-related information for transmission to a server system 220b of a payment processor (e.g., VISA). For example in another implementation, once the requisite number of information fields in an XML form displayed to the user 216 have been filled, the partially entered requested information 222 is automatically sent via the client device 218 to the server 220a as a request response 223. The server 220a processes the received request response 223 by packaging the partial transaction-related information for transmission to a server system 220b of a payment processor (e.g., VISA). The requisite number of information fields and type of information fields that trigger the ultimate transfer of the partial transaction-related information to the payment processor server 245b may be predetermined by criteria set by the payment processor entity and communicated by the payment processor server 245b to the triggered data-transfer application.

The above-described FPT process may generate a request for user information data (i.e., based on partial transaction-related information), e.g., 223, whereby, for example, the server, e.g., 220a, may receive a HTTP(S) POST request similar to the example below:

```
POST /requestuserinformation.php HTTP/1.1
Host: www.FPTprocess.com
Content-Type: Application/XML
Content-Length: 788
<?XML version = “1.0” encoding = “UTF-8”?>
<user_information_request>
  <timestamp>2011-02-22 17:00:01</timestamp>
  <user_account_params>
    <account_name>John Smith</account_name>
  </user_account_params>
  <purchase_summary>
    <num_products>1</num_products>
    <purchased_item>iPad tablet computer</purchased_item>
    <purchase_price>$560</purchase_price>
  </purchase_summary>
  <user_login>
    <user_name>jdoe</user_name>
    <user_password>jdoe1234abcde</user_password>
  </user_login>
</user_information_request>
```

However, prior to the transaction-related information being sent to the payment processor server system 220b by the merchant server 220a, the payment processor server system 220b identifies the merchant server 220a as a trusted website. Therefore, the merchant server 220a sends a server verification request 225 to the payment processor server system 220b, whereby the server verification request may for example, include a digital certificate. Once the payment processor server system 220b processes the received digital certificate, it may then determine that the merchant is a trusted website.

The above-described FPT process may generate a server verification request, e.g., 225, whereby, for example, the server, e.g., 220b, may receive a HTTP(S) POST request similar to the example below:

```
POST /verificationrequest.php HTTP/1.1
Host: www.FPTprocess.com
Content-Type: Application/XML
Content-Length: 788
<?XML version = “1.0” encoding = “UTF-8” ?>
<authentication_information>
  <digital_certificates>
    <num_certificates>3</num_certificates>
    <certificate1>public_key_certificate_1 </certificate1>
    <certificate1>public_key_certificate_2 </certificate1>
    <certificate1>public_key_certificate_3 </certificate1>
  </digital_certificates>
  <encryption>
    <hash1>hash_function_1</hash1>
    <hash2>hash_function_2</hash2>
  </encryption>
</authentication_information>
```

Upon a successful authentication of the merchant via the exchanged digital certificate, the merchant server 220a subsequently transmits the packaged partial transaction-related information to the payment processor server system 220b as a partial user identity information request 227. The partial user identity information request 227 may include a payment processor assigned merchant identifier (e.g., a user account ID), a payment processor assigned merchant password (e.g., a partner code assigned by the payment processor), and the partial transaction-related information.

The above-described FPT process may generate a user identity information message, e.g., 227, whereby, for example, the server, e.g., 220b, may receive a HTTP(S) POST message similar to the example below:

```
POST /useridentityinformation.php HTTP/1.1
Host: www.FPTprocess.com
Content-Type: Application/XML
Content-Length: 788
<?XML version = “1.0” encoding = “UTF-8”?>
<user_identity_information>
  <transaction_related_information>
    <timestamp>2011-02-22 17:00:01</timestamp>
    <user_account_params>
      <account_name>John Smith</account_name>
    </user_account_params>
    <purchase_summary>
      <num_products>1</num_products>
      <purchased_item>iPad tablet computer</purchased_item>
      <purchase_price>$560</purchase_price>
    </purchase_summary>
    <user_login>
      <user_name>jdoe</user_name>
      <user_password>jdoe1234abcde</user_password>
    </user_login>
  </transaction_related_information>
  <merchant_validation>
    <user_account_ID>12467JK</user_account_ID>
    <merchant_identifier>mm01111456asdrt</merchant_identifier>
    <merchant_secure_password>mm611asdrt
    </merchant_secure_password>
  </merchant_validation>
</user_identity_information>
```

The payment processor server system 220b processes the received partial user identity information message 227 by validating and generating user profile data from the received partial user identity information message 228. For example, the merchant may be further validated by processing the merchant identifier and merchant password that is received from the merchant server 220a at the payment processor server system 220b. Once there is validation of the merchant-generated user identity information, the information associated with the partial transaction-related information is utilized to query a user profile database 230 via a user profile query request 230a. Based on the user profile query request 230a, user profile data may be accessed 229 from the user profile database 230.

The above-described FPT process may generate a user-profile message, e.g., 228, whereby, for example, the server, e.g., 220b, may send a HTTP(S) POST message similar to the example below:

```
POST /userprofilemessage.php HTTP/1.1
Host: www.FPTprocess.com
Content-Type: Application/XML
Content-Length: 788
<?XML version = “1.0” encoding = “UTF-8”?>
<user_profile_information>
  <transaction_related_information>
    <timestamp>2011-02-22 17:00:01</timestamp>
    <user_account_params>
      <user_account_ID>1234567JS</ user_account_ID>
      <account_name>John Smith</account_name>
      <account_type>credit</account_type>
      <account_num>123455789012345</account_num>
      <account_expiry>01/01/2014</account_expiry>
    </user_account_params>
    <user_billing_information>
      <user_billing_address>3 Street Lane, New York, NY,
      10001, United States </user_billing_address>
      <user_telephone_number>01012345</user_telephone_number>
      <user_email_1>test@gmail.com</user_email_1>
      <user_email_2>test@hotmail.com</user_email_2>
      <user_residential_address>3 Street Lane, New York, NY,
      10001, United States</user_residential_address>
    </user_billing_information>
    <merchant_params>
      <merchant_id>3FBCR4INC</merchant_id>
      <merchant_name>Apple Store</merchant_name>
      <merchant_Industry>electronic goods</merchant_industry>
      <merchant_Location>Manhattan 10022</merchant_Location>
      <purchase_price>$599</purchase_price>
      <merchant_webaddress>www.applestore.com
      </merchant_webaddress>
    </merchant_params>
    <user_information>
      <date_of_birth>11/11/74</date_of_birth>
      <SSN>xxx_xx_xxxx</SSN>
      <gender>M</gender>
      <mobile_tel_number>917777745</mobile_tel_number>
    </user_information>
    <user_login>
      <user_name>jdoe</user_name>
      <user_password>jdoe1234abcde</user_password>
      <hint_question>what color?< </hint_question>
      <hint_answer>black</hint_answer>
      <optional_biometric_code>8941</optional_biometric_code>
    </user_login>
  </transaction_related_information>
  <merchant_validation>
    <merchant_identifier>mm01111456asdrt</merchant_identifier>
    <merchant_secure_password>mm611asdrt
    </merchant_secure_password>
  </merchant_validation>
  <user_matching_criteria>
    <criteria_number>4</criteria_number>
    <criteria_1>email_match</criteria_1>
    <criteria_2>account_name</criteria_2>
    <criteria_3>account_number</criteria_3>
    <criteria_4>user_password</criteria_4>
  </user_matching_criteria>
</user_profile_information>
```

The accessed user-profile 229 is then sent back to the merchant server 220a as a full user identity response 231. At the merchant server 220a, the user profile associated with the full user identity response 231 is processed 233 in order to populate any empty fields that may be required to be filled by the user 216 during the user or consumer's transaction (e.g., purchasing a sale item via the merchant website). In this manner, the accessed profile alleviates the user or consumer's need to enter all the fields of a form during an online transaction such as a sale purchase. Optionally, the accessed profile may be stored to the merchant server's database 230b (e.g., via an agreement by the payment processor). In such an implementation, the merchant may use the locally stored user profile at its database 230b for populating transaction forms presented to the user or consumer 216.

In one implementation, the accessed user profile populates any remaining fields that require populating (i.e., other than the partially entered information 222). For example, the fields that require populating include all remaining fields not populated by the user or consumer 216. According to another implementation, the accessed user profile may populate any remaining fields and re-populate any fields already populated. The re-population acts as a sanity check for incorrect information since any difference between a particular field entry by the user and a corresponding field within the user profile will be flagged, prompting the user to verify the correct information.

FIG. 2C is of a block diagram 200B illustrating example aspects of a profile merging process in some embodiments of the FPT. The user or consumer 240 may desire to make a user/consumer purchase by accessing and browsing web pages that are generated by a merchant server system 245a via a client device 242. In some example aspect, the client device 242 may be a user or consumer's 216 web-enable computer (e.g., laptop, desktop, tablet, etc.) or a mobile communication device (e.g., PDA, smartphone, etc.).

For example, during the browsing process, the user 240 may activate a hyperlink associated with purchasing a desired sale item (e.g., iPad) causing the client device 242 to generate a purchase item selection request 243 for processing by the merchant server 240a. In response to the purchase item selection request 243, the server 240a generates a user information request page 244 for facilitating the entry of transaction-related information by the user or consumer 240. Thus, the user 240 may enter partial transaction-related information 246 such as, for example, one or more of the user's name, the user's residential address, the user's billing address, the user's Email address(es), the user's credit card information, the user's username at merchant website, and user's password information at the merchant website.

A triggered data-transfer application executing on the merchant server 245a, or alternatively, remotely on the payment processor server 245b may detect and trigger a response to the user 240 that adequate information 246 has been entered. For example in one implementation, once the requisite number of information fields in an XML form displayed to the user 240 have been filled, a radio button (e.g., “GET PROFILE” button) may flash on the user's 240 browser. Once the button is activated by the user 240, the partially entered requested information 246 is then sent via the client device 242 to the server 245a as a request response 247. The server 245a processes the received request response 247 by packaging the partial transaction-related information for transmission to a server system 245b of a payment processor (e.g., VISA). For example in another implementation, once the requisite number of information fields in an XML form displayed to the user 216 have been filled, the partially entered requested information 246 is automatically sent via the client device 242 to the server 245a as a request response 247. The server 245a processes 248 the received request response 247 by packaging the partial transaction-related information for transmission to a server system 220b of a payment processor (e.g., VISA). The requisite number of information fields and type of information fields that trigger the ultimate transfer of the partial transaction-related information to the payment processor server 245b may be predetermined by criteria set by the payment processor entity and communicated by the payment processor server 245b to the triggered data-transfer application.

The above-described FPT process may generate a request for user information data (i.e., based on partial transaction-related information), e.g., 247, whereby, for example, the server, e.g., 245a, may receive a HTTP(S) POST request similar to the example below:

```
POST /requestuserinformation.php HTTP/1.1
Host: www.FPTprocess.com
Content-Type: Application/XML
Content-Length: 788
<?XML version = “1.0” encoding = “UTF-8”?>
<user_information_request>
  <timestamp>2011-02-22 17:00:01</timestamp>
  <user_account_params>
    <account_name>John Smith</account_name>
  </user_account_params>
  <purchase_summary>
    <num_products>1</num_products>
    <purchased_item>iPad tablet computer</purchased_item>
    <purchase_price>$560</purchase_price>
  </purchase_summary>
  <user_login>
    <user_name>jdoe</user_name>
    <user_password>jdoe1234abcde</user_password>
  </user_login>
</user_information_request>
```

However, prior to the transaction-related information being sent to the payment processor server system 245b by the merchant server 245a, the payment processor server system 245b identifies the merchant server 245a as a trusted website. Therefore, the merchant server 245a sends a server verification request 249 to the payment processor server system 245b, whereby the server verification request may for example, include a digital certificate. Once the payment processor server system 245b processes the received digital certificate, it may then determine that the merchant is a trusted website.

The above-described FPT process may generate a server verification request, e.g., 249, whereby, for example, the server, e.g., 245b, may receive a HTTP(S) POST request similar to the example below:

```
POST /verificationrequest.php HTTP/1.1
Host: www.FPTprocess.com
Content-Type: Application/XML
Content-Length: 788
<?XML version = “1.0” encoding = “UTF-8”?>
<authentication_information>
  <digital_certificates>
    <num_certificates>3</num_certifictes>
    <certificate1>public_key_certificate_1 </certificate1>
    <certificate1>public_key_certificate_2 </certificate1>
    <certificate1>public_key_certificate_3 </certificate1>
  </digital_certificates>
  <encryption>
    <hash1>hash_function_1</hash1>
    <hash2>hash_function_2</hash2>
  </encryption>
</authentication_information>
```

Upon a successful authentication of the merchant via the exchanged digital certificate, the merchant server 245a subsequently transmits the packaged partial transaction-related information to the payment processor server system 245b as a partial user identity information request 251. The partial user identity information request 251 may include a payment processor assigned merchant identifier (e.g., a user account ID), a payment processor assigned merchant password (e.g., a partner code assigned by the payment processor), and the partial transaction-related information.

The above-described FPT process may generate a user identity information message, e.g., 251, whereby, for example, the server, e.g., 245b, may receive a HTTP(S) POST message similar to the example below:

```
POST /useridentityinformation.php HTTP/1.1
Host: www.FPTprocess.com
Content-Type: Application/XML
Content-Length: 788
<?XML version = “1.0” encoding = “UTF-8”?>
<user_identify_information>
  <transaction_related_information>
    <timestamp>2011-02-22 17:00:01</timestamp>
    <user_account_params>
      <account_name>John Smith</account_name>
    </user_account_params>
    <purchase_summary>
      <num_products>1</num_products>
      <purchased_item>iPad tablet computer</purchased_item>
      <purchase_price>$560</purchase_price>
    </purchase_summary>
    <user_login>
      <user_name>jdoe</user_name>
      <user_password>jdoe1234abcde</user_password>
    </user_login>
  </transaction_related_information>
  <merchant_validation>
    <user_account_ID>12467JK</user_account_ID>
    <merchant_identifier>mm01111456asdrt</merchant_identifier>
    <merchant_secure_password>mm611asdrt
    </merchant_secure_password>
  </merchant_validation>
</user_identity_information>
```

The payment processor server system 220b processes the received partial user identity information message 251 by validating and determining user profile data from the received partial user identity information message 253. For example, the merchant may be further validated by processing the merchant identifier and merchant password that is received from the merchant server 245a at the payment processor server system 245b. Once there is validation of the merchant-generated user identity information, during processing 253, the information associated with the partial transaction-related information is utilized to query a user profile database 256 via a user profile query request 257. Based on the user profile query request 257, user profile data may be accessed 257 from the user profile database 256.

The above-described FPT process may generate a user-profile message, e.g., 228, whereby, for example, the server, e.g., 220b, may send a HTTP(S) POST message similar to the example below:

```
POST /userprofilemessage.php HTTP/1.1
Host: www.FPTprocess.com
Content-Type: Application/XML
Content-Length: 788
<?XML version = “1.0” encoding = “UTF-8”?>
<user_profile_information>
  <transaction_related_information>
    <timestamp>2011-02-22 17:00:01</timestamp>
    <user_account_params>
      <user_account_ID>1234567JS</ user_account_ID>
      <account_name>John Smith</account_name>
      <account_type>credit</account_type>
      <account_num>123455789012345</account_num>
      <account_expiry>01/01/2014</account_expiry>
    </user_account_params>
    <user_billing_information>
      <user_billing_address>3 Street Lane, New York, NY,
      10001, United States </user_billing_address>
      <user_telephone_number>01012345</user_telephone_number>
      <user_email_1>test@gmail.com</user_email_1>
      <user_email_2>test@hotmail.com</user_email_2>
      <user_residential_address>3 Street Lane, New York, NY,
      10001, United States</user_residential_address>
    </user_billing_information>
    <merchant_params>
      <merchant_id>3FBCR4INC</merchant_id>
      <merchant_name>Apple Store</merchant_name>
      <merchant_Industry>electronic goods</merchant_industry>
      <merchant_Location>Manhattan 10022</merchant_Location>
      <purchase_price>$599</purchase_price>
      <merchant_webaddress>www.applestore.com
      </merchant_webaddress>
    </merchant_params>
    <user_information>
      <date_of_birth>11/11/74</date_of_birth>
      <SSN>xxx_xx_xxxx</SSN>
      <gender>M</gender>
      <mobile_tel_number>917777745</mobile_tel_number>
    </user_information>
    <user_login>
      <user_name>jdoe</user_name>
      <user_password>jdoe1234abcde</user_password>
      <hint_question>what color?< </hint_question>
      <hint_answer>black</hint_answer>
      <optional_biometric_code>8941</optional_biometric_code>
    </user_login>
  </transaction_related_information>
  <merchant_validation>
    <merchant_identifier>mm01111456asdrt</merchant_identifier>
    <merchant_secure_password>mm611asdrt
    </merchant_secure_password>
  </merchant_validation>
  <user_matching_criteria>
    <criteria_number>4</criteria_number>
    <criteria_1>email_match</criteria_1>
    <criteria_2>account_name</criteria_2>
    <criteria_3>account_number</criteria_3>
    <criteria_4>user_password</criteria_4>
  </user_matching_criteria>
</user_profile_information>
```

The accessed user-profile 257 and the received partial user identity information are further processed 254 in order to determine additional information that is present in the partial user identity and not available within the user profile. If there are differences between the partial user identity and the user profile data, a new user profile is generated from the partial user identity data 254. The generated new user profile is then stored 255 as a new entry in the user profile database 256.

The above-described FPT process may generate a new user-profile message, e.g., 254, whereby, for example, the server, e.g., 245b, may send a HTTP(S) POST message similar to the example below:

```
POST /userprofilemessage.php HTTP/1.1
Host: www.FPTprocess.com
Content-Type: Application/XML
Content-Length: 788
<?XML version = “1.0” encoding = “UTF-8”?>
<user_profile_information>
  <transaction_related_information>
    <timestamp>2011-02-22 17:00:01</timestamp>
    <user_account_params>
      <user_account_ID2>1234JS</ user_account_ID2>
      <account_name>John Smith</account_name>
      <account_type2>credit2</account_type2>
      <account_num>1234557AAA</account_num>
      <account_expiry>01/01/2017</account_expiry>
    </user_account_params>
    <user_billing_information>
      <user_billing_address>3 Street Lane, New York, NY,
      10001, United States </user_billing_address>
      <user_telephone_number>01012345</user_telephone_number>
      <user_email_1>test@gmail.com</user_email_1>
      <user_email_2>test@hotmail.com</user_email_2>
      <user_residential_address>3 Street Lane, New York, NY,
      10001, United States</user_{—} residential_address>
    </user_billing_information>
    <user_login>
      <user_name>jdoe</user_name>
      <user_password>jdoe1234abcde</user_password>
      <hint_question>what color?< </hint_question>
      <hint_answer>black</hint_answer>
      <optional_biometric_code>8941</optional_biometric_code>
    </user_login>
  </transaction_related_information>
  <merchant_validation>
    <merchant_identifier>mm01111456asdrt</merchant_identifier>
    <merchant_secure_password>mm611asdrt
    </merchant_secure_password>
  </merchant_validation>
  <user_matching_criteria>
    <criteria_number>3</criteria_number>
    <criteria_1>email_match</criteria_1>
    <criteria_2>account_name</criteria_2>
    <criteria_3>user_password</criteria_3>
  </user_matching_criteria>
</user_profile_information>
```

The payment processor server 245b queries 258 a matching criteria database 256a in order to access a set of matching criteria for determining whether two or more user profile entries within the user profile database 256 are associated with the same user or consumer 240. For example, the criteria may look to match a user or consumer's 240 email address and user name within the user profiles of the user profile database 256. Using the matching criteria, (e.g., email & username) it is verified that the new user profile and the accessed user profile are a match 259 (e.g., email and username match) and are, therefore, associated with the same user or consumer 240. Thus, the accessed profile data and the new user profile data are merged in order to generate a merged profile that includes the common data between the accessed and new profile and any additional information present in one profile and not in the other. The merged user profile data is then stored 260 in the user profile database 257 as an updated user profile.

The above-described FPT process may generate a matching criteria request, e.g., 258, whereby, for example, the server, e.g., 245b, may send a HTTP(S) POST message similar to the example below:

```
POST /matchingcriteria.php HTTP/1.1
Host: www.FPTprocess.com
Content-Type: Application/XML
Content-Length: 788
<?XML version = “1.0” encoding = “UTF-8”?>
<user_matching_criteria>
  <criteria_option_1>
    <criteria_number>3</criteria_number>
    <criteria_1>email_match</criteria_1>
    <criteria_2>account_name_match</criteria_2>
    <criteria_3>user_password_match</criteria_3>
  </criteria_option_1>
  <criteria_option_2>
    <criteria_number>2</criteria_number>
    <criteria_1>mobile_telephone_number_match</criteria_1>
    <criteria_2>account_name_match</criteria_2>
  </criteria_option_2>
  <criteria_option_3>
    <criteria_number>5</criteria_number>
    <criteria_1>email_match</criteria_1>
    <criteria_2>account_name_match</criteria_2>
    <criteria_3>account_number_match</criteria_3>
    <criteria_4>date_of_birth_match</criteria_3>
  </criteria_option_3>
  <criteria_option_4>
    <criteria_number>4</criteria_number>
    <criteria_1>user_information_prompt_1_match</criteria_1>
    <criteria_2>user_information_prompt_2_match</criteria_2>
    <criteria_3>user_information_prompt_3_match</criteria_3>
    <criteria_4>user_information_prompt_4_match</criteria_4>
  </criteria_option_4>
</user_matching_criteria>
```

The above-described FPT process may generate a merged user-profile message, e.g., 260, whereby, for example, the server, e.g., 245b, may send a HTTP(S) POST message similar to the example below:

```
POST /userupdatedprofilemessage.php HTTP/1.1
Host: www.FPTprocess.com
Content-Type: Application/XML
Content-Length: 788
<?XML version = “1.0” encoding = “UTF-8”?>
<user_profile_information>
  <transaction_related_information>
    <timestamp>2011-02-22 17:00:01</timestamp>
    <user_account_params>
      <user_account_ID2>1234JS</ user_account_ID2>
      <account_name>John Smith</account_name>
      <account_type2>credit2</account_type2>
      <account_num>1234557AAA</account_num>
      <account_expiry>01/01/2017</account_expiry>
      <user_account_ID>1234567JS</ user_account_ID>
      <account_name>John Smith</account_name>
      <account_type>credit</account_type>
      <account_num>123455789012345</account_num>
      <account_expiry>01/01/2014</account_expiry>
    </user_account_params>
    <user_billing_information>
      <user_billing_address>3 Street Lane, New York, NY,
      10001, United States </user_billing_address>
      <user_telephone_number>01012345</user_telephone_number>
      <user_email_1>test@gmail.com</user_email_1>
      <user_email_2>test@hotmail.com</user_email_2>
      <user_residential_address>3 Street Lane, New York, NY,
      10001, United States</user_{—} residential_address>
    </user_billing_information>
    <user_login>
      <user_name>jdoe</user_name>
      <user_password>jdoe1234abcde</user_password>
      <hint_question>what color?< </hint_question>
      <hint_answer>black</hint_answer>
      <optional_biometric_code>8941</optional_biometric_code>
    </user_login>
  </transaction_related_information>
  <merchant_validation>
    <merchant_identifier>mm01111456asdrt</merchant_identifier>
    <merchant_secure_password>mm611asdrt
    </merchant_secure_password>
  </merchant_validation>
  <user_matching_criteria>
    <criteria_number>3</criteria_number>
    <criteria_1>email_match</criteria_1>
    <criteria_2>account_name</criteria_2>
    <criteria_3>user_password</criteria_3>
  </user_matching_criteria>
</user_profile_information>
```

The merged user profile is also sent back to the merchant server 245a as a full user identity response 261. At the merchant server 245a, the merged user profile associated with the full user identity response 261 is processed 262 in order to populate any empty fields that may be required to be filled by the user 240 during the user or consumer's transaction (e.g., purchasing a sale item via the merchant website). In this manner, the accessed profile alleviates the user or consumer's need to enter all the fields of a form during an online transaction such as a sale purchase. Optionally (e.g., via an agreement by the payment processor), the accessed profile may be stored to the merchant server's database (not shown for brevity). In such an implementation, the merchant may use the locally stored user profile at its database for populating transaction forms presented to the user or consumer 240.

Regarding FIGS. 2A-2C, although for brevity a single merchant server (e.g., 206a) is illustrated in each figure, in some implementations multiple merchant servers may communicate user identity information with the payment processor server (e.g., 206b), whereby the multiple user identity information associated with one or more transactions with each of the multiple merchant servers is used to create a user profile for the user or consumer (e.g., 201). Further, according to other implementations, the payment processor server (e.g., 206b) may prompt the user or consumer for additional information (e.g., mobile telephone number, mobile device type, date of birth, etc.) in order to facilitate the creation of the user of consumer's profile.

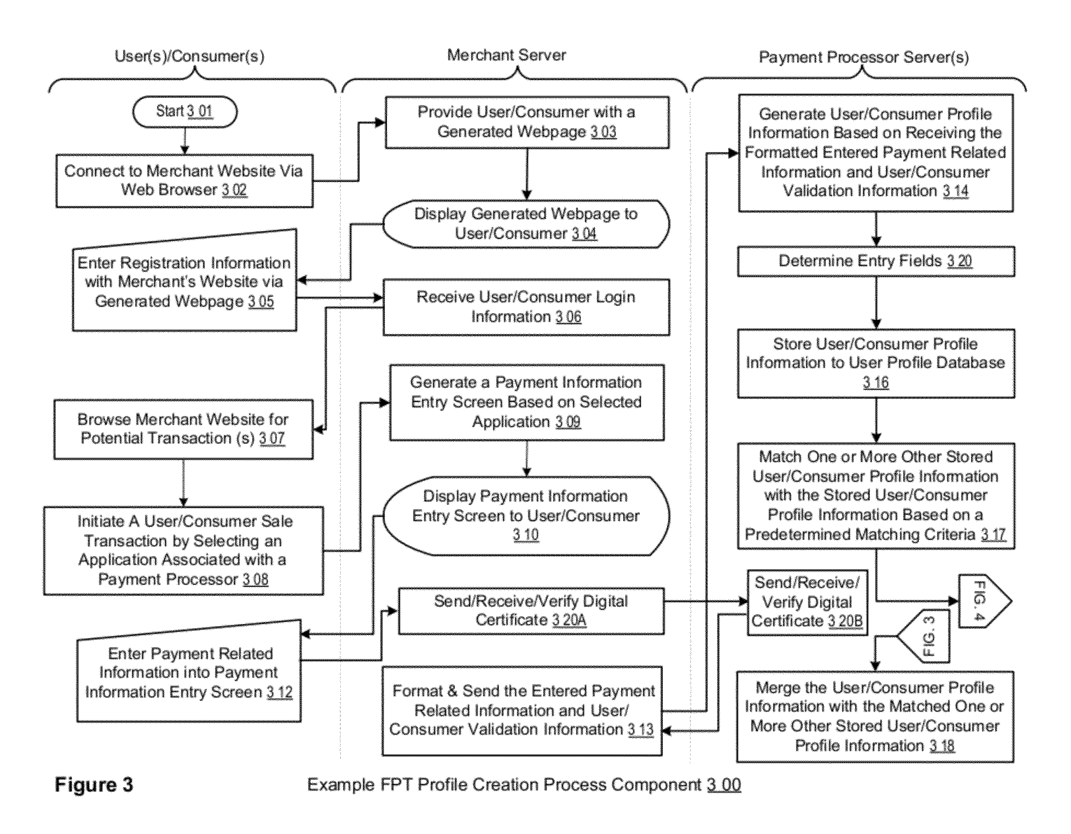

FIG. 3 is of a logic flow diagram 300 illustrating a profile creation, matching, and merging process in some embodiments of the FPT. A user or consumer connects to a website via their web browser 302. Based on the user interacting (e.g., hyperlink selection) with the merchant's website, the merchant server provides the user or consumer with a generated webpage (e.g., to perform a sale purchase transaction) 303. The merchant server displays the generated webpage to the user 304, which subsequently provides the user with the opportunity to enter registration information associated with the merchant 305. The registration information may include, for example, creating a username and password for the merchant website, additional verification information (e.g., biometrics and/or security challenge response questions) the user's contact information (e.g., email), etc.

Following registration, the merchant server receives the user's login information (e.g., username/password) 306. The user then continues to browse the merchant's website 307 in order to, for example, make a potential transaction (e.g., purchase an item). The user may initiate a sale transaction by selecting a payment application associated with a payment processor 308. Based on the application selection, the merchant's server may then generate a payment information entry screen 309, which is subsequently displayed to the user or consumer 310. The user may then enter transaction related information such as payment related information into the payment entry screen 312 generated by the merchant server. Once the payment related information is received by the merchant's server, a digital certificate is exchanged between the merchant's server 320A and the payment processor's server 320B. Once the merchant's server and the payment processor's server determine the authenticity of the exchanged digital certificate, the merchant server formats (packetize) and sends the entered payment related information and additional consumer validation information (e.g., username and password of user at merchant website) to the payment processor's server 313.

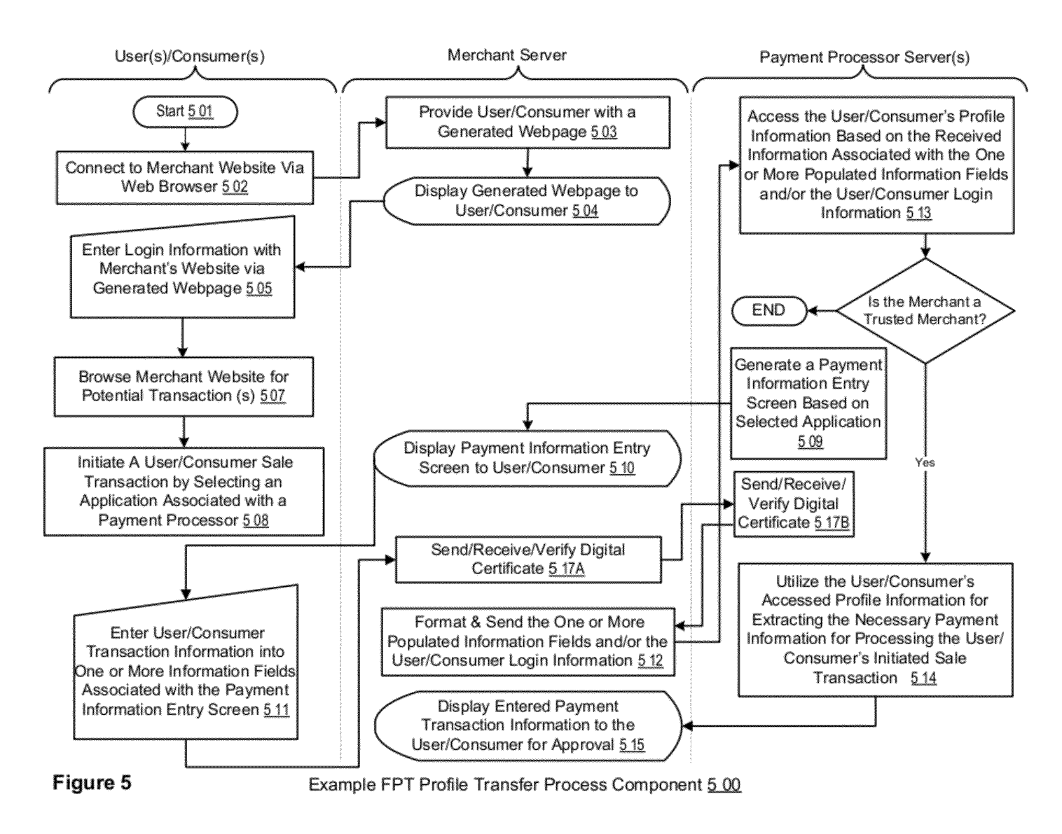

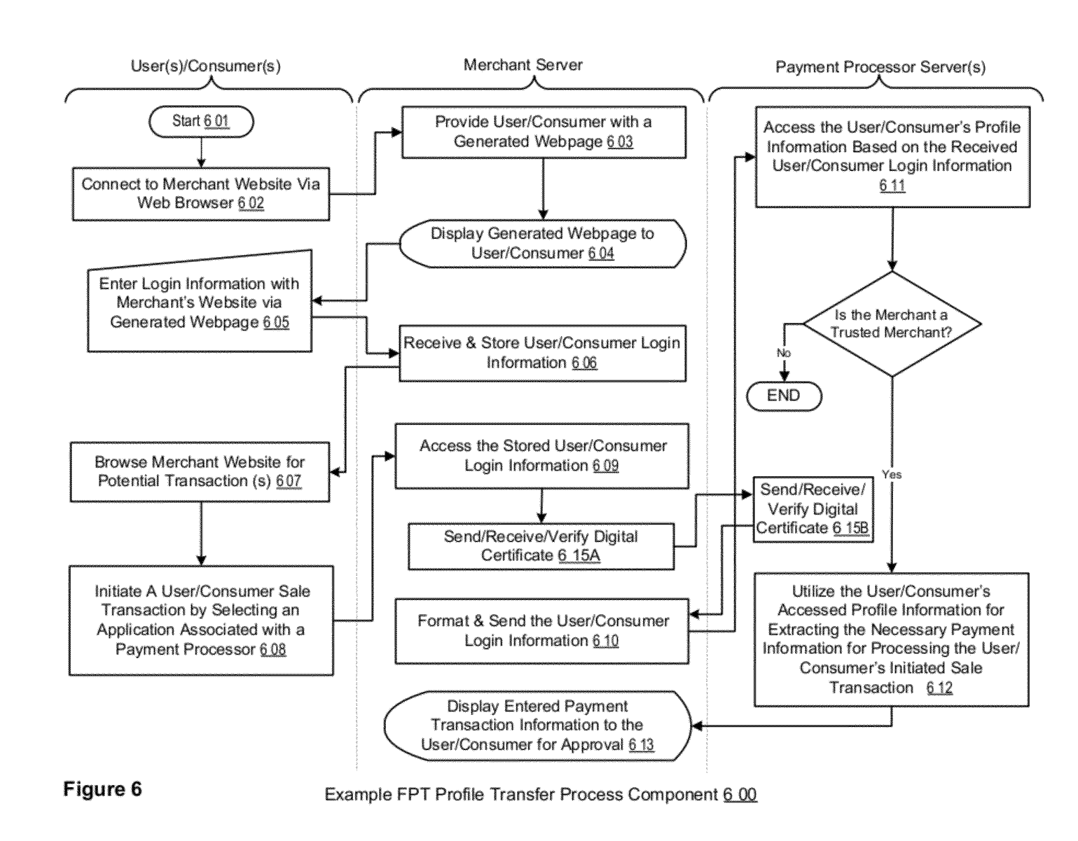

In an alternative implementation, the exchange of a digital certificate 320A, 320B may not be necessary. For example, the payment processor server system may provide the merchant server with a hash function for encrypting/decrypting any information (e.g., packaged transaction-related information) that is exchanged between the merchant server and the payment processor server. The same alternative implementation applies to FIGS. 5 and 6 described below.

At the payment processor's server, a user profile for the user or consumer is generated based on the received entered payment related information and the additional consumer validation information (e.g., username and password of user at merchant website) 314. Once the fields for creating the user profile are determined 320, the payment related information and additional consumer validation information are parsed and applied to the determined fields. For example, the user's email within the payment related information may be assigned to an email field of the user profile, etc.

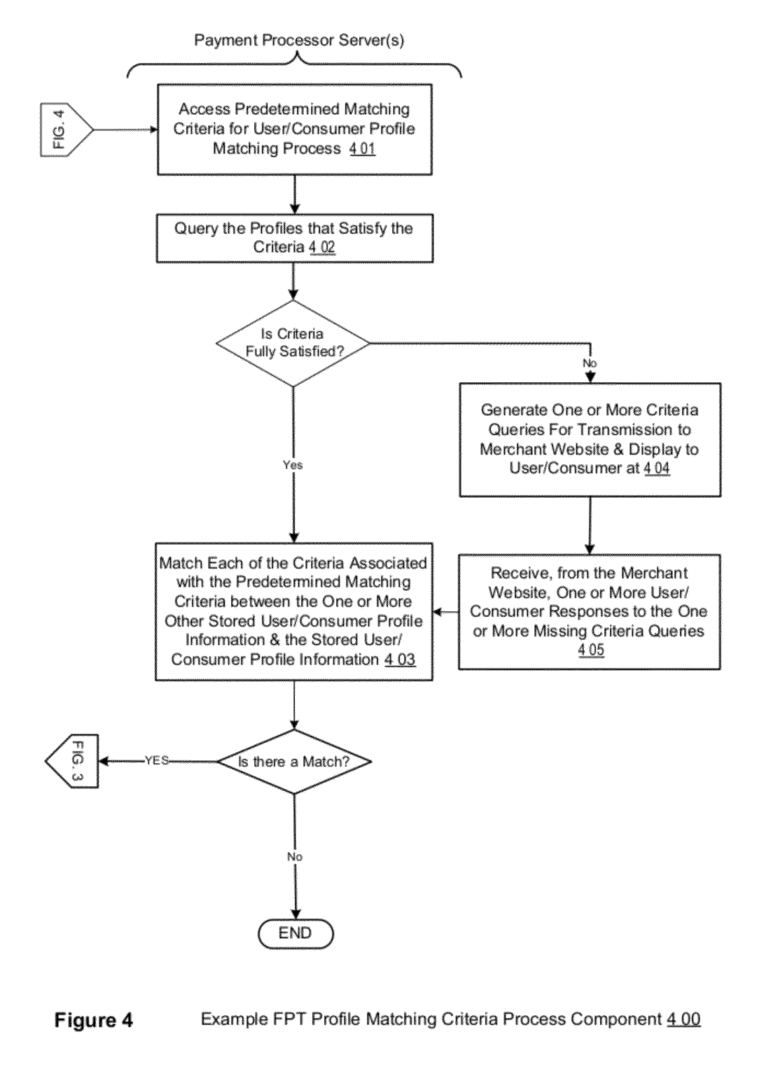

The generated user profile is then stored to a user profile database 316, whereby the information within the generated user profile is matched with other stored user/consumer profile information associated one or more other user profiles within the database 317. Referring to FIG. 4, in order to determine such a match, the payment processor's server accesses (e.g., from storage such as a database) a predetermined matching criteria 401. For example, the matching criteria may include matching four fields within the stored user profiles. The matching criteria may also specify which fields are to be matched (e.g., user's name, user's bank account number, and user's email, user's SSN).

Once the matching criteria are selected 401, the payment processor's server queries the stored (e.g., within a payment processor database) user profiles that satisfy the predetermined criteria 402. For example the payment processor's server may determine that five (5) user profiles satisfy a predetermined criteria of having fields such as a user's name, a user's bank account number, a user's email, and a user's SSN. If the criteria are fully satisfied, the profiles that satisfy the criteria are matched in order determine if their respective fields match. For example, based on determining five (5) user profiles that fully satisfy the predetermined criteria of having a user's name, a user's bank account number, a user's email, and a user's SSN, the contents of each of these fields is subsequently processed in order to determine a match 403. For example, of the five user profiles that fully satisfy the predetermined criteria, two (2) may have fields that all match each other. Referring to FIG. 3, if there is a match between two or more profiles, the two or more matched profiles are merged to create a single updated user profile that includes all the information within the individual matched user profiles 318.

Referring back to FIG. 4, if a user profile does not have a criteria match with any other profiles within the database, the matching criteria may dynamically change by generating one or more criteria queries for transmission to the user merchant's server for display to the user or consumer 404. For example, if a predetermined criteria of having fields such as a user's name, a user's bank account number, a user's email, and a user's SSN is not fully satisfied based of no matches having an email address field, the criteria may be changed to include a user's telephone number as an added criterion. Thus, the user may be prompted to add their telephone number at the merchant website 404, whereby the merchant's server then transmits the telephone number to the payment processor server 405 for resuming the matching of the profile fields 403.

FIG. 5 is of a logic flow diagram 500 illustrating a profile access process in some embodiments of the FPT. A user or consumer connects to a website via their web browser 502. Based on the user interacting (e.g., hyperlink selection) with the merchant's website, the merchant server provides the user or consumer with a generated webpage (e.g., to perform a sale purchase transaction) 503. The merchant server displays the generated webpage to the user 504, which subsequently provides the user with the opportunity to enter login information associated with the merchant 505.

The user then continues to browse the merchant's website 507 in order to, for example, make a potential transaction (e.g., purchase an item). The user may initiate a sale transaction by using a payment application/widget associated with a payment processor 508. Based on an application/widget generated by the payment processor (e.g., a javascript or AJAX lightbox), a payment information entry screen 509 is generated, which is subsequently displayed to the user or consumer via the merchant's server 510. The user may then enter one or more transaction related information fields such as payment related information into the payment entry screen 511 generated by the payment processor server on the merchant's server. Once the payment related information is received by the merchant's server, a digital certificate is exchanged between the merchant's server 517A and the payment processor's server 517B. Once the merchant's server and the payment processor's server determine the authenticity of the exchanged digital certificate, the merchant server formats (packetize) and sends the entered one or more transaction related information fields and/or additional consumer validation information (e.g., username and password of user at merchant website) to the payment processor's server 513. Based on the received populated one or more transaction related information fields and/or the additional consumer validation information (e.g., username and password of user at merchant website), the payment processor server accesses the user or consumer's profile.

The payment processor's server may further optionally determine the merchant as a trusted merchant by accessing and processing prior transactions with the merchant. Also, the merchant server may send a payment-processer-assigned merchant user-ID and/or a payment-processer-assigned merchant password for verification by the payment processor server. If it is determined that the merchant is an un-trusted entity (i.e., bad credit transactions etc.), the profile transfer process ends. If the merchant is trusted, the accessed user or consumer's profile is utilized for extracting the necessary payment information for processing the user or consumer's initiated sale transaction 514. For example, the accessed profile is transferred to the merchant's server in order to populate and display the remaining fields of the payment information entry screen without requiring the user or consumer to type in this information 515.

FIG. 6 is of a logic flow diagram 600 illustrating another profile access process in some embodiments of the FPT. A user or consumer connects to a website via their web browser 602. Based on the user interacting (e.g., hyperlink selection) with the merchant's website, the merchant server provides the user or consumer with a generated webpage (e.g., to perform a sale purchase transaction) 603. The merchant server displays the generated webpage to the user 604, which subsequently provides the user with the opportunity to enter login information associated with the merchant 605, whereby entered login information is received stored by the merchant's server 606.

The user then continues to browse the merchant's website 607 in order to, for example, make a potential transaction (e.g., purchase an item). The user may initiate a sale transaction by selecting a payment application associated with a payment processor 608. Based on an application (e.g., payment processor related application) selection, the merchant's server may then access the stored user or consumer's login information. Once the login information is accessed by the merchant's server, a digital certificate is exchanged between the merchant's server 615A and the payment processor's server 615B. Once the merchant's server and the payment processor's server determine the authenticity of the exchanged digital certificate, the merchant server formats (packetize) and sends the user or consumer's login information to the payment processor's server 610. Based on the received login information, the payment processor server accesses the user or consumer's profile 611.

The payment processor's server may further optionally determine the merchant as a trusted merchant by accessing and processing prior transactions with the merchant. Also, the merchant server may send a payment-processer-assigned merchant user-ID and/or a payment-processer-assigned merchant password for verification by the payment processor server. If it is determined that the merchant is an un-trusted entity (i.e., bad credit transactions etc.), the profile transfer process ends. If the merchant is trusted, the accessed user or consumer's profile is utilized for extracting the necessary payment information for processing the user or consumer's initiated sale transaction 612. For example, the accessed profile is transferred to the merchant's server in order to populate and display the remaining fields of the payment information entry screen without requiring the user or consumer to type in this information 613.

### FIE

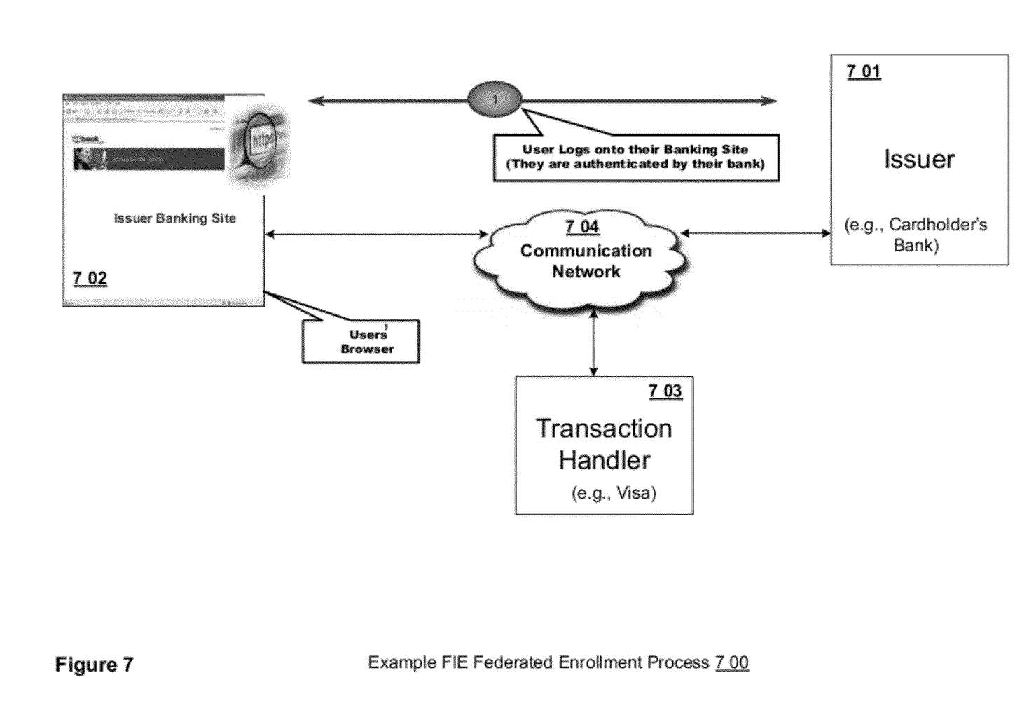

FIG. 7 is of a block diagram 700 illustrating a FEDERATED INTERNET ENROLLMENT SYSTEM (hereinafter “FIE system”). One or more embodiments of the FIE system provide federated internet website (branded) enrollment, whereby a first entity, such as an issuer of a consumer's account, verifies or authenticates the identity of the consumer who is engaging a website on the Internet via operation of a browser installed on a client (e.g., a computing apparatus). The first entity then, in an out of band communication, transfers trust to a second entity, such as a transaction handler (e.g., Visa, Inc., MasterCard, etc.), thereby verifying the identity of the consumer to the second entity without the second entity requiring additional input (e.g., a sign-on process) from the consumer. The second entity, therefore, can engage in a secure online transaction with the consumer using the identifying information provided by the first entity.

According to the embodiment illustrated in FIG. 7, a consumer, using a web browser running on a processing device (i.e., a web-enabled device), accesses a webpage, such as webpage 702, by a web service provider such as issuer 701. Issuer 701 may be an issuer of an account held by the user or consumer. In certain implementations, the web-enabled device is a personal computer, a notebook computer, or other personal computing device. In certain implementations, the web-enabled device may be a cellular telephone, a smartphone, or a personal digital assistant (PDA). In certain implementations, the web-enabled device may be an MP3 player. In certain other implementations, the web-enabled device may include a video game player.

As will be apparent to one of ordinary skill in the art, the consumer may browse to a website hosted by the server of an entity other than an issuer without departing from the present invention. In certain implementations, the entity may be an acquirer or a transaction handler (e.g., Visa, Inc., Master Card, etc.). In certain implementations, the entity may be a third-party who has stored financial information concerning the consumer, such as an online brokerage firm, an online retailer, or other entity with whom the consumer has previously engaged in a financial transaction. In other implementations, the entity may include any entity capable of providing a website wherein the identity and account information of the consumer is verified. Examples of such entities may include various organizations within the healthcare industry or the U.S. governmental (e.g., Social Services).

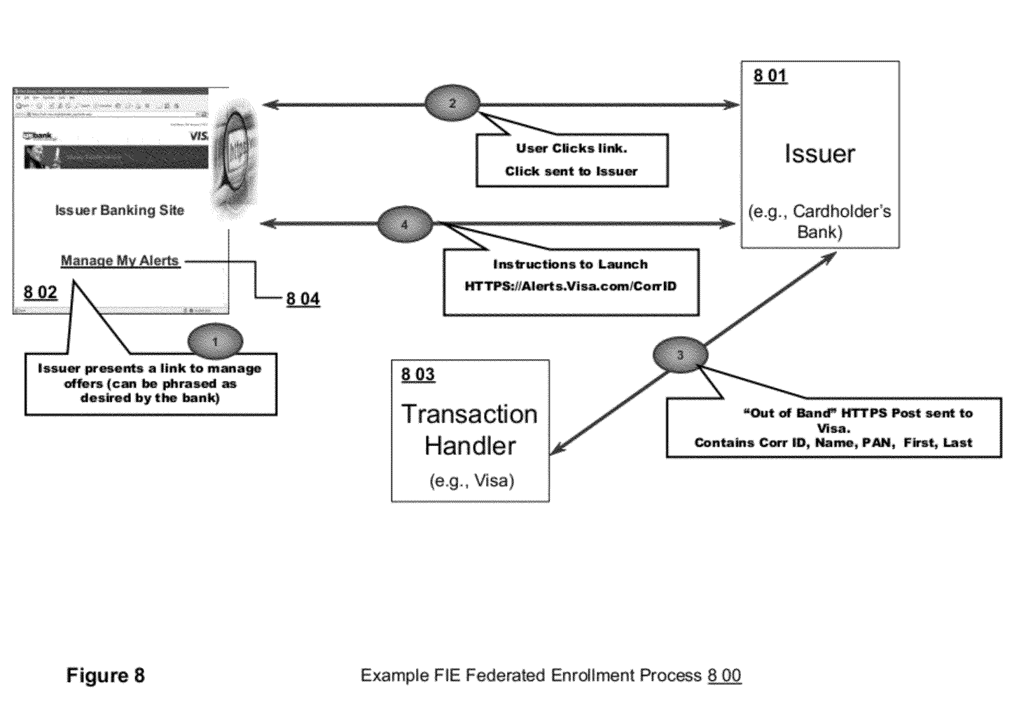

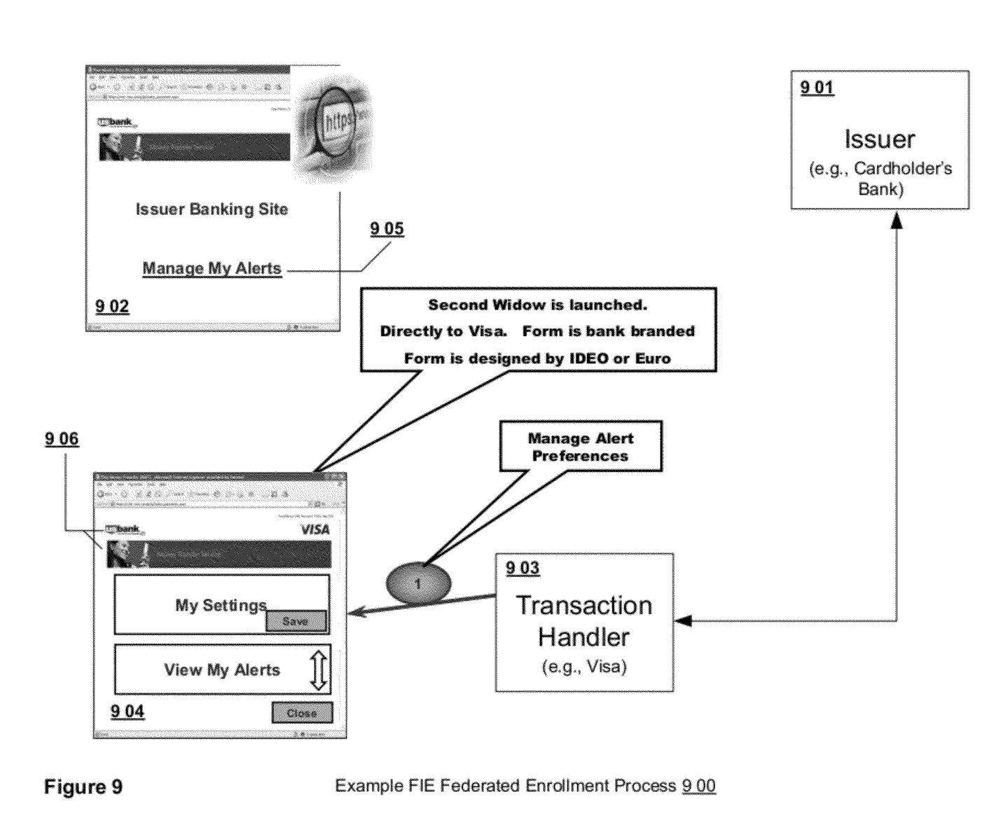

Once the consumer has browsed to the webpage 702 of the issuer 701, via one or more communication networks 704, the consumer is subsequently authenticated by the issuer 701. According to one implementation, the issuer 701 may require the user or consumer to login using a password and user identification. In other implementations, the consumer may provide additional, identifying information, such as, by way of example and not limitation, home address, account number, social security number, birth date, or similar personal information. In certain implementations, the consumer answers security information, such as, by way of example and not limitation, their mother's maiden name, place of birth, first pet's name, or other information personal to the consumer. In certain implementations, the consumer chooses a security question to be asked each time they login to webpage 702 when they establish their account with issuer 701. In certain implementations, the security question is randomly selected from a set of security questions to which the consumer has previously provided answers. In certain implementations, other methods of securely logging into a website are used. Such implementations may include the use of, but are not limited to, fingerprint scans, retinal scans, iris scans, face recognition, voice imprints, or other biometric identifiers. In certain implementations, two or more of the foregoing methods of securely logging into a website are employed. The communication network 104 generally facilitates the transmission and reception of information (e.g., data) between issuer(s), transaction handler(s), and user(s) using one or more communication protocols such as, for example, TCP/IP. Although, for brevity, a communication network has not been displayed in FIGS. 8 and 9, it will be assumed that any communications between the issuer, transaction handler, and user may be via one or more communication networks operating using wireless transmission protocols (e.g., 802.11 standards), wired transmission protocols (e.g., Internet Protocol), or any combination thereof.

FIG. 8 is of a block diagram 80o further illustrating one or more aspects of the FIE. Once the consumer has provided the security information required by issuer 801 to log into webpage 802, the consumer's web browser renders a second secure webpage 802. In certain implementations, as shown at reference numeral “1,” webpage 802 presents a link 804 to a service provided by a third party such as transaction handler 803. By way of example and not limitation, if selected, link 804 may enroll the user or consumer in a service, provide personal information, initiate a transaction on the consumer's account with a merchant (e.g., an electronic commerce (e-commerce) transaction), or otherwise engage the consumer with a third party.

As shown at reference numeral “2,” when the consumer engages link 804 (i.e., Manage My Alerts), the issuer 801 may send an out-of-band message to transaction handler 803, as shown at reference numeral “3.” An “out-of-band” message may refer to a communication which occurs outside of a previously established communication channel. Thus, the out-of-band communication between issuer 801 and transaction handler 803 (i.e., reference numeral “3”) may occur separately from the currently existing and established communication channel between the consumer's processing device used for viewing webpage 802 and the issuer 801 that has generated the webpage 802 (i.e., reference numeral “4”). Furthermore, because the communication between issuer the 810 and transaction handler 803 is out-of-band, the communication is transparent (i.e., unknown) to the consumer.

The out-of-band communication between the issuer 810 (who issued an account to the consumer) and the transaction handler 803 (e.g., Visa, Inc., Master Card, etc.) identifies the user or consumer who is logged into webpage 802 and who has engaged link 804. Thus, transaction handler 803 inherits the trust that has been established between the issuer 801 (e.g., user or consumer's bank) and the consumer that is currently viewing the accessed webpage 802 previously generated by the issuer 801 upon authentication of the consumer. The trust may be transferred to the transaction handler 803 irrespective of the method in which it was established with issuer 801. Thus, for example, ‘Bank ABC’ may require consumers to provide a user name, password, and the answer to a security question while ‘Bank 123’ may require a user name and biometric key such as a fingerprint. However, despite the different security procedures used, all that is required for the trust to transfer to transaction handler 803 is for either Bank ABC or Bank 123 to verify to the transaction handler 803 that the consumer's identity has been validated. As such, transaction handler 803 may not need to require the consumer to provide any additional information to verify the consumer's identity.

In one implementation, the out-of-band communication may include the consumer's name. In another implementation, the communication may include the consumer's Primary Account Number (PAN). In certain implementations, the communication may include a correlation identifier, where the correlation identifier may be a 16-bit or 32-bit alpha-numeric value that identifies the consumer to transaction handler 203.

The out-of-band communication may be established by the issuer 801 sending a HTTPS POST request, which allows for the transfer of data from the issuer 801 to the transaction handler 803. The HTTPS POST request may contain, for example, the consumer's correction identifier, the consumer's name, and the consumer's Primary Account Number (PAN). In one implementation additional security may be provided by including the consumer's device information (e.g., computer or smartphone device information). Moreover, the out-of-band communications may be protected by digital certificate on both the issuer 801 and the transaction handler 803 side.

FIG. 9 is also of a block diagram 900 further illustrating one or more aspects of the FIE. As illustrated in FIG. 9, according to one implementation, upon receiving the out-of-band message, a pop-up window 902 is presented to the user or consumer. The pop-up window 902 is provided by the transaction handler 903, as indicated by reference numeral “1.” A pop-up window, or daughter window, may be a window that opens in its own browser window. In such an implementation, the URL of the pop-up window may directly indicate that the pop-up window is generated by the transaction handler's 903 server, as opposed to by the issuer's 901 server. For example, referring back to FIG. 8, the consumer may have been logged into: https://bankABC.com/myaccount (e.g., webpage 802) prior to engaging link 804. However, the pop-up window may have a URL of: https://alerts.ransactionhandler.com/corrID, where “corrID” represents the correlation identifier, described above.

According to one implementation, the transaction handler's 903 server may cause an iframe to open within webpage 902 of the consumer's browser, whereby an iframe may refer to an inline frame that contains another document. Frames allow browser windows to be split into segments, each of which presents a different document. Thus, in one such implementation, while the content of most of the browser may be provided by a server operated by issuer 901, the content of the iframe may be provided by a server operated by transaction handler 903.

In certain implementations, other means in addition to iframes and/or daughter windows may be employed. In such implementations, the consumer may be directed to another webpage.

As illustrated in FIG. 9, according to another implementation, a daughter window, iframe, or other webpage generated by transaction handler 903 may be branded, whereby the daughter window, iframe, or other webpage may appear to be provided by the issuer 901 and formatted to have a similar look-and-feel to the webpages provided by issuer 901 (e.g., trademarks, trade names, logos, and other identifying characteristics). In such implementations, therefore, the user or consumer may be unaware that the daughter window, iframe, or other webpage is actually provided by the transaction handler 903 (e.g., VISA) rather than by the issuer 901 (e.g., US Bank). For example, as indicated by reference numeral “1,” when the consumer or user selects link 905 within webpage 902 of the issuer 901, the transaction handler 903 generates an additional branded window 904 that appears to be generated from within the issuer's webpage 902. For example, although the branded window 904 is generated by the transaction handler 903, the issuer's 901 logo (i.e., USbank) and banner 906 may be included within the webpage 904.

In certain implementations, the consumer or user may not be able to change any pre-designated information that is transferred from the issuer 901 during the out-of-band communication with the transaction handler 903. This ensures that the identity of the consumer cannot be altered. In such implementations, the consumer may only be allowed to adjust preferential information such as, for example, how the consumer prefers to receive alerts.

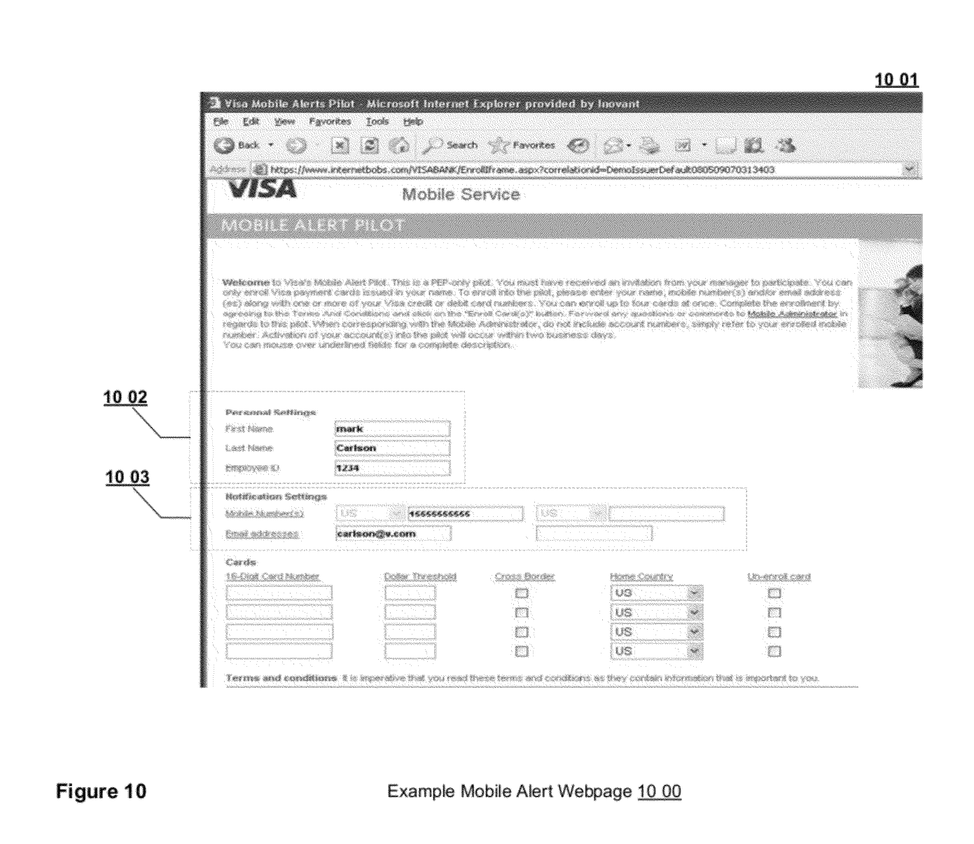

FIG. 10 illustrates such an implementation 1000, where a pop-up window 1001 is provided by the transaction handler according to one or more aspects of the FIE. As illustrated and described above, the transaction handler (e.g., 903) may generate and display window 1001 to the consumer, which occurs upon the transaction handler (e.g., 903) receiving the existing transferred trust (i.e., between the issuer/consumer) from the issuer (e.g., 901). For example, as shown in FIG. 10, pre-designated information 1002 such the consumer's first name (e.g., Mark), last name (e.g., Carlson), and employee ID (e.g., 1134) may be transferred during the out-of-band communication and transfer of trust. Thus, this pre-designated information 1002 may, in some instances, not be edited by the consumer simply by changing the fields within the window 1001. The consumer may, however, edit preferential information such as, for example, notification settings 1003, which establish how the consumer prefers to receive alerts. For example, using entry fields and/or drop-down menus from within window 1001, “Mark Carlson” may set his notification settings so that he receives alerts via both his email at Carlson@v.com and Mobile Number of 1555555555.

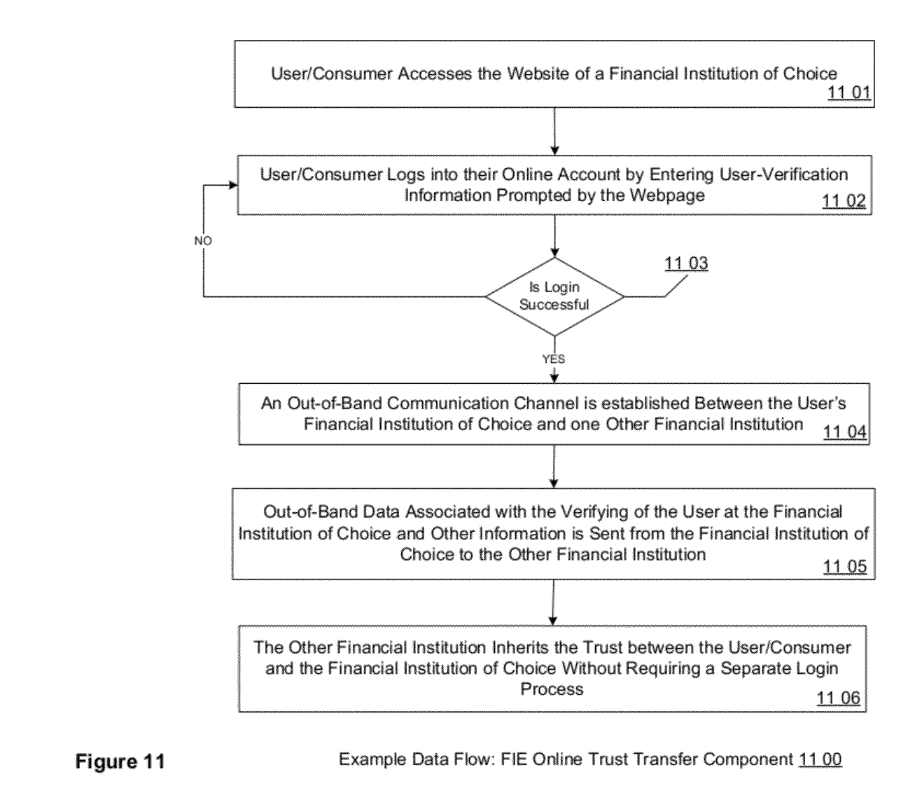

FIG. 11 illustrates a flow diagram 1100 for transferring online trust between entities such as financial institutions according to one or more aspects of the FIE. Accordingly, a user or consumer may access a website that corresponds to one of their financial institutions 1101 (e.g., USbank). The user may then proceed to enter user-verification information (e.g., username, password, biometric input, answer to presented security question, etc.) that is presented within the downloaded webpage received from the accessed website of the financial institution 1102. Upon the user entering and confirming (e.g., pressing a Sign-In button) the user-verification information 1102, the financial institution receives and validates the user-verification information sent from the user's web browser (e.g., Explorer, Firefox, etc.). Thus, based on the received verification information, the financial institution makes a determination as to whether the user's login process was successful or not 1103.

If the received verification information matches that which is on file at the financial institution, the user or consumer may be presented with a webpage of their personal financial information and have the ability to navigate their online personal account(s). While the user is logged onto their account at the financial institutions website, the financial institution may generate an out-of-band transmission (e.g., HTTPS POST message) for verifying the user to at least one other financial institution (e.g., VISA) 1104. In addition to verifying the user to the other financial institution, the out-of-band transmission may, for example, include other information such as an assigned correlation ID, the user's name, and the user's primary account number 1105.

Thus, upon receiving the verification information of the user, the other financial institution (e.g., VISA) inherits the trust that was already established when the user logged onto their financial institution of choice (i.e., USbank) 1106. As described and illustrated in relation to FIGS. 7-10, once the financial institutions have an established trust, for example, a transaction handler, e.g., 903, may generate a window displaying secure user financial information, e.g., 904, by selecting a hyperlink that is located within the webpage, e.g., 902, of the issuer bank, e.g., 901. Alternatively, rather than generating a window, for example, the transaction handler, e.g., 903, may embed the information accessible by the hyperlink, e.g., 904, as an inline frame within the webpage, e.g., 902, of an issuer bank, e.g., 901. The transfer of trust, therefore, permits the exchange of secure information without the requisite need for a separate sign-on at the website of the transaction handler, e.g., 903.

### FPT/FIE Controller

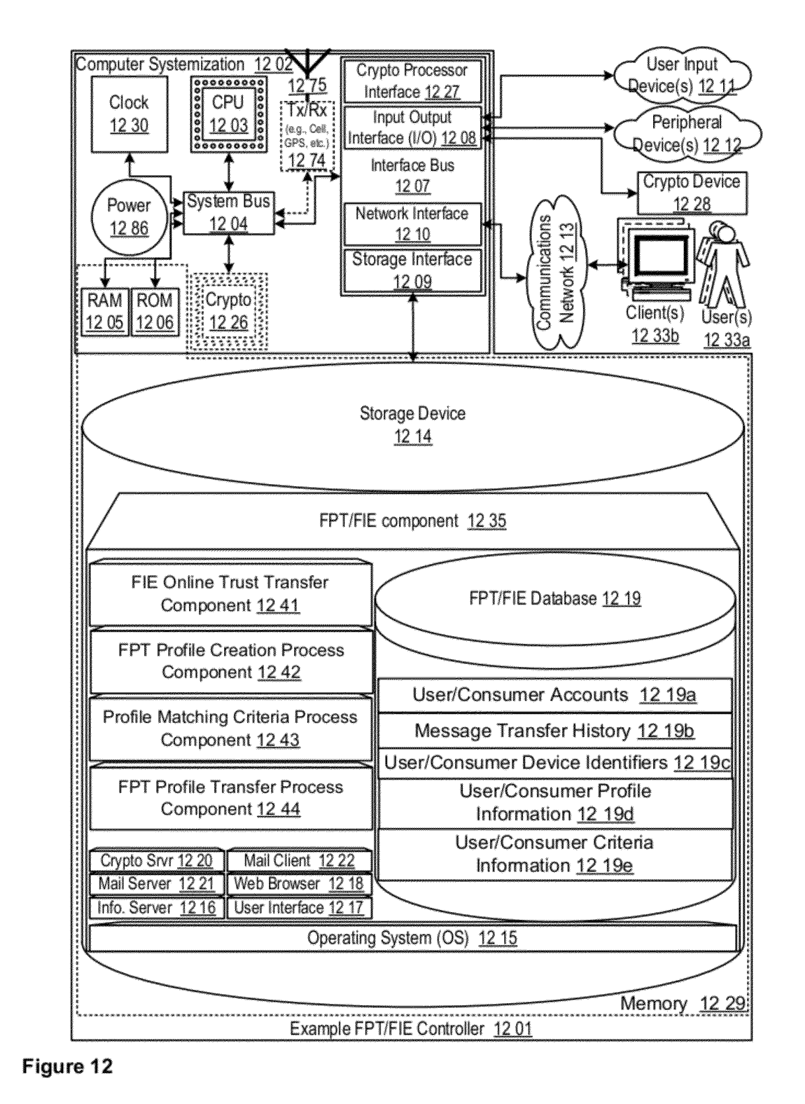

FIG. 12 illustrates inventive aspects of a FPT/FIE controller 1201 in a block diagram. In this embodiment, the FPT controller 1201 may serve to aggregate, process, store, search, serve, identify, instruct, generate, match, and/or facilitate interactions with a computer through various technologies, and/or other related data.

Typically, users, which may be people and/or other systems, may engage information technology systems (e.g., computers) to facilitate information processing. In turn, computers employ processors to process information; such processors 1203 may be referred to as central processing units (CPU). One form of processor is referred to as a microprocessor. CPUs use communicative circuits to pass binary encoded signals acting as instructions to provide various operations. These instructions may be operational and/or data instructions containing and/or referencing other instructions and data in various processor accessible and operable areas of memory 1229 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system provides and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the FPT/FIE controller 1201 may be connected to and/or communicate with entities such as, but not limited to: one or more users from user input devices 1211; peripheral devices 1212; an optional cryptographic processor device 1228; and/or a communications network 1213.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The FPT/FIE controller 1201 may be based on computer systems that may comprise, but are not limited to, components such as: a computer systemization 1202 connected to memory 1229.

### Computer Systemization

A computer systemization 1202 may comprise a clock 1230, central processing unit (“CPU(s)” and/or “processor(s)” (these terms are used interchangeable throughout the disclosure unless noted to the contrary)) 1203, a memory 1229 (e.g., a read only memory (ROM) 1206, a random access memory (RAM) 1205, etc.), and/or an interface bus 1207, and most frequently, although not necessarily, are all interconnected and/or communicating through a system bus 1204 on one or more (mother)board(s) 1202 having conductive and/or otherwise transportive circuit pathways through which instructions (e.g., binary encoded signals) may travel to effect communications, operations, storage, etc. Optionally, the computer systemization may be connected to an internal power source 1286. Optionally, a cryptographic processor 1226 may be connected to the system bus. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 1229 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the FPT/FIE controller and beyond through various interfaces. Should processing requirements dictate a greater amount speed and/or capacity, distributed processors (e.g., Distributed FPT/FIE), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the FPT/FIE may be achieved by implementing a microcontroller such as CAST's R8051XC2 microcontroller; Intel's MCS 51 (i.e., 8051 microcontroller); and/or the like. Also, to implement certain features of the FPT/FIE, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the FPT/FIE component collection (distributed or otherwise) and/or features may be implemented via the microprocessor and/or via embedded components; e.g., via ASIC, coprocessor, DSP, FPGA, and/or the like. Alternately, some implementations of the FPT/FIE may be implemented with embedded components that are configured and used to achieve a variety of features or signal processing.

Depending on the particular implementation, the embedded components may include software solutions, hardware solutions, and/or some combination of both hardware/software solutions. For example, FPT/FIE features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the FPT/FIE features. A hierarchy of programmable interconnects allow logic blocks to be interconnected as needed by the FPT/FIE system designer/administrator, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the FPT/FIE may be developed on regular FPGAs and then migrated into a fixed version that more resembles ASIC implementations. Alternate or coordinating implementations may migrate FPT/FIE controller features to a final ASIC instead of or in addition to FPGAs. Depending on the implementation all of the aforementioned embedded components and microprocessors may be considered the “CPU” and/or “processor” for the FPT.

### Power Source

The power source 686 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1286 is connected to at least one of the interconnected subsequent components of the FPT/FIE thereby providing an electric current to all subsequent components. In one example, the power source 1286 is connected to the system bus component 1204. In an alternative embodiment, an outside power source 1286 is provided through a connection across the I/O 1208 interface. For example, a USB and/or IEEE 1394 connection carries both data and power across the connection and is therefore a suitable source of power.

### Interface Adapters

Interface bus(ses) 1207 may accept, connect, and/or communicate to a number of interface adapters, conventionally although not necessarily in the form of adapter cards, such as but not limited to: input output interfaces (I/O) 1208, storage interfaces 1209, network interfaces 1210, and/or the like. Optionally, cryptographic processor interfaces 1227 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1209 may accept, communicate, and/or connect to a number of storage devices such as, but not limited to: storage devices 1214, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1210 may accept, communicate, and/or connect to a communications network 1213. Through a communications network 1213, the FPT/FIE controller is accessible through remote clients 1233b (e.g., computers with web browsers) by users 1233a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed FPT/FIE), architectures may similarly be employed to pool, load balance, and/or otherwise increase the communicative bandwidth required by the FPT/FIE controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 1210 may be used to engage with various communications network types 1213. For example, multiple network interfaces may be employed to allow for the communication over broadcast, multicast, and/or unicast networks.

Input Output interfaces (I/O) 1208 may accept, communicate, and/or connect to user input devices 1211, peripheral devices 1212, cryptographic processor devices 1228, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless: 802.11a/b/g/n/x, Bluetooth, code division multiple access (CDMA), global system for mobile communications (GSM), WiMax, etc.; and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 1211 may be card readers, dongles, finger print readers, gloves, graphics tablets, joysticks, keyboards, mouse (mice), remote controls, retina readers, trackballs, trackpads, and/or the like.

Peripheral devices 1212 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the FPT/FIE controller may be embodied as an embedded, dedicated, and/or monitor-less (i.e., headless) device, wherein access would be provided over a network interface connection.

Cryptographic units such as, but not limited to, microcontrollers, processors 1226, interfaces 1227, and/or devices 1228 may be attached, and/or communicate with the FPT/FIE controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 1229. However, memory is a fungible technology and resource, thus, any number of memory embodiments may be employed in lieu of or in concert with one another. It is to be understood that the FPT/FIE controller and/or a computer systemization may employ various forms of memory 1229. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 1229 will include ROM 1206, RAM 1205, and a storage device 1214. A storage device 1214 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 1229 may contain a collection of program and/or database components and/or data such as, but not limited to: operating system component(s) 1215 (operating system); information server component(s) 1216 (information server); user interface component(s) 1217 (user interface); Web browser component(s) 1218 (Web browser); database(s) 1219; mail server component(s) 1221; mail client component(s) 1222; cryptographic server component(s) 1220 (cryptographic server); the online trust transfer component(s) 1241; the FPT/FIE component(s) 1235; and/or the like (i.e., collectively a component collection). These components may be stored and accessed from the storage devices and/or from storage devices accessible through an interface bus. Although non-conventional program components such as those in the component collection, typically, are stored in a local storage device 1214, they may also be loaded and/or stored in memory such as: peripheral devices, RAM, remote storage facilities through a communications network, ROM, various forms of memory, and/or the like.

### Operating System

The operating system component 1215 is an executable program component facilitating the operation of the FPT/FIE controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may establish the interaction with communications networks, data, I/O, peripheral devices, program components, memory, user input devices, and/or the like. The operating system may provide communications protocols that allow the FPT/FIE controller to communicate with other entities through a communications network 1213. Various communication protocols may be used by the FPT controller as a subcarrier transport mechanism for interaction, such as, but not limited to: multicast, TCP/IP, UDP, unicast, and/or the like.

### Information Server

An information server component 1216 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the FPT controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the FPT/FIE database 1219, operating systems, other program components, user interfaces, Web browsers, and/or the like.

Access to the FPT/FIE database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the FPT/FIE. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the FPT/FIE as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 1217 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 1218 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the FPT/FIE enabled nodes. The combined application may be nugatory on systems employing standard Web browsers.

### Mail Server

A mail server component 1221 is a stored program component that is executed by a CPU 1203. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP₃), simple mail transfer protocol (SMTP), and/or the like. The mail server can route, forward, and process incoming and outgoing mail messages that have been sent, relayed and/or otherwise traversing through and/or to the FPT/FIE.

Access to the FPT/FIE mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 1222 is a stored program component that is executed by a CPU 1203. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 1220 is a stored program component that is executed by a CPU 1203, cryptographic processor 1226, cryptographic processor interface 1227, cryptographic processor device 1228, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the FPT/FIE may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to allow the FPT/FIE component to engage in secure transactions if so desired. The cryptographic component facilitates the secure accessing of resources on the FPT/FIE and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The FPT/FIE Database

The FPT/FIE database component 1219 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the FPT/FIE database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the FPT/FIE database is implemented as a data-structure, the use of the FPT/FIE database 1219 may be integrated into another component such as the FPT/FIE component 1235. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 1219 includes several tables 1219a-e. A Consumer Accounts table 1219a includes fields such as, but not limited to: a user_id, first_name, last_name, user_issuer_bank_account_info, user_acquirer_institution_account_info, user_credit_rating, and/or the like. The Consumer Accounts 619a table may support and/or track the various financial institutions that are associated with multiple users' or consumers' on a FPT/FIE.

A Message Transfer History table 1219b includes fields such as, but not limited to: correlation_id, message_time_stamp, message_date_stamp, issuer_id, transaction_handler_id, and trust_status. Further, a Consumer Device Identifier table 1219c includes fields such as, but not limited to: user_id, user_device_id, device_communication_protocol, browser_software, browser_software_version, last_browser_SW_update, and/or the like.

A User/Consumer Profile Information table 1219d includes fields such as, but not limited to: timestamp, user_account_ID, account_name, account_type, account_num, account_expiry, user_billing_information, user_telephone_number, user_email, merchant_id, merchant_name, merchant_Industry, merchant_Location, purchase_price, merchant_webaddres, user_date_of_birth, SSN, gender, mobile_tel_number, user_name, user_password, hint_question, hint_answer, optional_biometric_code, merchant_identifier, merchant_secure_password, and a user_matching_criteria.

A User/Consumer Criteria Information table 1219e includes fields such as, but not limited to: criteria_number, email_match, account_name_match, user_password_match, mobile_telephone_number_match, account_number_match, date_of_birth_match, and user_information_prompt_match.

In one embodiment, the FPT/FIE database may interact with other database systems. For example, employing a distributed database system, queries and data access by search FPT/FIE component may treat the combination of the FPT/FIE database, an integrated data security layer database as a single database entity.

In one embodiment, user programs may contain various user interface primitives, which may serve to update the FPT/FIE. Also, various accounts may require custom database tables depending upon the environments and the types of clients the FPT/FIE may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 1219a-f. The FPT/FIE may be configured to keep track of various settings, inputs, and parameters via database controllers.

The FPT/FIE database may communicate to and/or with other components in a component collection, including itself, and/or facilities of the like. Most frequently, the FPT/FIE database communicates with the FPT/FIE component, other program components, and/or the like. The database may contain, retain, and provide information regarding other nodes and data.

### The FPT/FIE

The FPT/FIE component 1235 is a stored program component that is executed by a CPU. In one embodiment, the FPT/FIE component incorporates any and/or all combinations of the aspects of the FPT/FIE that was discussed in the previous figures. As such, the FPT/FIE affects accessing, obtaining and the provision of information, services, transactions, and/or the like across various communications networks.

The FPT/FIE component transforms user identity information inputs associated with transactions at a merchant website into a user-profile output that is transferred to other merchant websites for facilitating one or more other transactions without the requisite need for full user re-entry of information. In addition, the FPT/FIE component also transforms authentication inputs for establishing trust between a user or consumer and the user or consumer's financial institution into a trust transfer output that further establishes trust between the user or consumer and another financial institution.

The FPT/FIE component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the FPT/FIE server employs a cryptographic server to encrypt and decrypt communications. The FPT/FIE component may communicate to and/or with other components in a component collection, including itself, and/or facilities of the like. Most frequently, the FPT/FIE component communicates with the FPT/FIE database, operating systems, other program components, and/or the like. The FPT/FIE may contain, communicate, generate, obtain, and/or provide program component, system, user, and/or data communications, requests, and/or responses.

### Distributed FPTs

The structure and/or operation of any of the FPT/FIE node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the FPT/FIE controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), local and remote application program interfaces Jini, Remote Method Invocation (RMI), SOAP, process pipes, shared files, and/or the like. Messages sent between discrete component components for inter-application communication or within memory spaces of a singular component for infra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., the SOAP parser) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the FPT/FIE controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(‘Content-Type: text/plain’);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message
do {
  $input = “”;
  $input = socket_read($client, 1024);
  $data .= $input;
} while($input != “”);
// parse data to extract variables
$obj = json_decode($data, true);
// store input data in a database
mysql_connect(“201.408.185.132”,$DBserver,$password); // access
database server
mysql_select(“CLIENT_DB.SQL”); // select database to append
mysql_query(“INSERT INTO UserTable (transmission)
VALUES ($data)”); // add data to UserTable table in a CLIENT database
mysql_close(“CLIENT_DB.SQL”); // close connection to database
?>
```

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=
/com.ibm.IBMDI.doc/referenceguide295.htm

and other parser implementations:

http://publib.boulder.ibm.com/infocenter/tivihelp/v2r1/index.jsp?topic=
/com.ibm.IBMDI.doc/referenceguide259.htm

all of which are hereby expressly incorporated by reference.

In order to address various issues and improve over previous works, the application is directed to FEDERATED THIRD-PARTY AUTHENTICATION APPARATUSES, METHODS AND SYSTEMS. The entirety of this application (including the Cover Page, Title, Headings, Field, Background, Summary, Brief Description of the Drawings, Detailed Description, Claims, Abstract, Figures, Appendices, and otherwise) shows by way of illustration various embodiments in which the claimed inventions may be practiced. The advantages and features of the application are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims. It is to be understood that, depending on the particular needs and/or characteristics of a FPT/FIE individual and/or enterprise user, database configuration and/or relational model, data type, data transmission and/or network framework, syntax structure, and/or the like, various embodiments of the FPT/FIE, may be implemented that provide a great deal of flexibility and customization. For example, aspects of the FPT/FIE may be adapted for any wireless or connection-oriented internet-based system that provides the transfer of trust between entities. For example, once a first financial institution authenticates a user seeking access to a secure website of the first financial institution, the established trust associated with the communication link between the user and the first financial institution may be transferred to a second financial institution. Upon the second financial institution receiving an out-of-band message authenticating the user, a level of trust is now established between the user and the second financial institution. Once this trust is received, the second financial institution generates and communicates information (e.g., web-content) that is displayed on the user's web browser as, for example, an inline frame within the user's current webpage or within a pop-up window. While various embodiments and discussions of the FPT/FIE have been directed the transfer of trust and information between financial institutions, however, it is to be understood that the embodiments described herein may be readily configured and/or customized for a wide variety of other applications and/or implementations.

What is claimed is:

1. A user authentication transfer processor-implemented method comprising:
establishing a first trust indication associated with a first merchant;
receiving first user-transaction-related information from a server of the first merchant based on a user entering the first user-transaction-related information;
generating a first user-profile for the user based on the first user-transaction-related information received from the server of the first merchant;
establishing a second trust indication associated with a second merchant; and
sending the first user-profile to the second merchant based on the established first and second trust indications, wherein the first user-profile provides the first user-transaction-related information for facilitating transactions by the user at a server of the second merchant.

2. The method of claim 1, wherein the first user-transaction-related information is partial and incomplete user profile information.

3. The method of claim 1, wherein the authentication transfer facilitates a payment transaction.

4. The method of claim 1, wherein the first user-transaction-related information is complete user profile information.

5. The method of claim 1, wherein facilitating transactions includes populating a profile creation form at a second merchant.

6. The method of claim 1, wherein populating includes pre-population of a profile creation form at a second merchant.

7. The method of claim 1, further comprising:
receiving second user-transaction-related information from the server of the second merchant;
generating a second user-profile for the user based on the second user-transaction-related information received from the server of the second merchant;
matching the first user-transaction-related information within the first user-profile with the second user-transaction-related information within the second user-profile according to a predefined matching criteria; and
merging the first and the second user-profile into an updated profile based on meeting the predetermined matching criteria.

8. The method of claim 7, wherein the server comprises a website or a mobile application.

9. The method of claim 1, wherein the first trust indication is established based on prior payment processing activities with the first merchant, and the second trust indication is established based on prior payment processing activities with the second merchant.

10. The method of claim 1, wherein the first trust indication is established based on at least one of: authenticating a first user-account-id corresponding to the first merchant and an established encryption/decryption process associated with the server of the first merchant.

11. The method of claim 1, wherein the second trust indication is established based on at least one of: authenticating a second user-account-id corresponding to the second merchant and an established encryption/decryption process associated with the server of the second merchant.

12. The method of claim 7, wherein the first user-transaction-related information comprises at least one of: a user-login-id, a user-login-password, a user-name, a user-surname, a user date of birth, a user gender-identifier, at least one user credit card information, at least one user email address, a user billing address, a user credit card address, a user IP-address, a mobile telephone number, unique device identifier, payment method information, bank account identifier.

13. The method of claim 7, wherein the second user-transaction-related information comprises at least one of: a user-id, a user-password, a user-name, a user-surname, a user date of birth, a user gender-identifier, at least one user credit card information, at least one user email address, a user billing address, a user credit card address, and a user IP-address.

14. The method of claim 7, further comprising:
storing the updated profile to a user-profile database.

15. The method of claim 7, wherein the predetermined criteria comprises determining at least one match between the first user-transaction-related information and the second user-transaction-related information.

16. The method of claim 7, wherein the predetermined criteria comprises determining a match between a plurality of fields associated with the first user-transaction-related information and a plurality of fields associated with the second user-transaction-related information.

17. The method of claim 7, further comprising:
generating at least one user-related question associated with the first user-transaction-related information for presentation to the user, wherein the at least one user-related question is prompted based on a failure to meet the predetermined matching criteria.

18. The method of claim 17, wherein the generating and presentation of the at least one user-related question comprises the user generating a response to the at least one user-related question.

19. The method of claim 18, further comprising:
performing, according to the predefined matching criteria, a subsequent matching of the first user-transaction-related information within the first user-profile with the second user-transaction-related information within the second user-profile based on the response by the user; and
generating the updated profile based on the subsequent matching meeting the predefined matching criteria.

20. The method of claim 7, further comprising:
determining the user accessing a server of at least one other merchant;
establishing a trust indication associated with the at least one other merchant; and
sending the updated user-profile to the at least one other merchant based on the established trust, wherein the updated user-profile provides the first and the second user-transaction-related information for facilitating transactions by the user at the server of the at least one other merchant.

21. The method of claim 20, wherein the determining of the user accessing the server of at least one other merchant comprises:
receiving a merchant user-account-id corresponding to the at least one other merchant based on the user making a payment transaction.

22. The method of claim 20, wherein the determining of the user accessing the server of at least one other merchant comprises:
receiving a merchant user-account-id corresponding to the at least one other merchant based on the user logging onto the website of the at least one other merchant.

23. The method of claim 20, wherein the trust indication is established based on at least one of: authenticating a user-account-id corresponding to the at least one other merchant and an established encryption/decryption process associated with the server of the at least one other merchant.

24. A user authentication transfer system, comprising:
a memory; and
a processor disposed in communication with the memory and configured to issue processing instructions stored in the memory to:
establish a first trust indication associated with a first merchant;
receive first user-transaction-related information from a server of the first merchant based on a user entering the first user-transaction-related information;
generate a first user-profile for the user based on the first user-transaction-related information received from the server of the first merchant;
establish a second trust indication associated with a second merchant; and
send the first user-profile to the second merchant based on the established first and second trust indications, wherein the first user-profile provides the first user-transaction-related information for facilitating transactions by the user at a server of the second merchant.

25. The system of claim 24, further comprising:
receiving second user-transaction-related information from the server of the second merchant;
generating a second user-profile for the user based on the second user-transaction-related information received from the server of the second merchant;
matching the first user-transaction-related information within the first user-profile with the second user-transaction-related information within the second user-profile according to a predefined matching criteria; and
merging the first and the second user-profile into an updated profile based on meeting the predetermined matching criteria.

26. A processor-readable tangible medium storing processor-issuable user authentication transfer instructions to:
establish a first trust indication associated with a first merchant;
receive first user-transaction-related information from a server of the first merchant based on a user entering the first user-transaction-related information;
generate a first user-profile for the user based on the first user-transaction-related information received from the server of the first merchant;
establish a second trust indication associated with a second merchant; and
send the first user-profile to the second merchant based on the established first and second trust indications, wherein the first user-profile provides the first user-transaction-related information for facilitating transactions by the user at a server of the second merchant.

27. The system of claim 26, further comprising:
receiving second user-transaction-related information from the server of the second merchant;
generating a second user-profile for the user based on the second user-transaction-related information received from the server of the second merchant;
matching the first user-transaction-related information within the first user-profile with the second user-transaction-related information within the second user-profile according to a predefined matching criteria; and
merging the first and the second user-profile into an updated profile based on meeting the predetermined matching criteria.

28. A user authentication processor-implemented method to transform first authentication information at a first entity to second authentication information at a second entity, comprising:
receiving authentication information of a user at a first server corresponding to a first entity;
validating the authentication information received at the server website, wherein upon validation of the authentication information, the user is provided access to content on the first website;
generating, from the first website, an out-of-band message for transmission to a second website corresponding to a second entity, wherein the out-of-band message includes an indication of the validation of the authentication information corresponding to the user; and
sending content on the second website for display to the user based on the second server receiving the indication.

29. The method of claim 28, wherein the out-of-band message is generated by selecting a hyperlink provided within a webpage displaying the content on the first website to the user.

30. A user authentication method for transferring trust between a first and a second entity over a communication network, comprising:
sending, via a processing device, authentication information of a user to a first website corresponding to a first entity;
validating the authentication information received at the first website, wherein upon validation of the authentication information, the user is provided access to content on the first website;
sending an out-of-band message from the first website to a second website corresponding to a second entity, wherein the out-of-band message includes an indication of the validation of the authentication information corresponding to the user; and
sending content on the second website for display to the user based on the second website receiving the indication.

31. The method of claim 30, wherein the out-of-band message is generated by selecting a hyperlink provided within a webpage displaying the content on the first website to the user.

32. The method of claim 30, further comprising:
providing user information within the out-of-band message.

33. The method of claim 30, wherein the first and the second entity are a first and a second financial institution, respectively.

34. The method of claim 30, wherein the out-of-band message comprises an HTTPS POST message.

35. The method of claim 30, wherein the display to the user includes:
displaying on a browser associated with the user an inline frame that incorporates the content on the second website within a webpage displaying the content on the first website to the user.

34. The method of claim 30, wherein the content on the second website is accessed by the user selecting a hyperlink provided within the webpage displaying the content on the first website.

35. The method of claim 30, wherein the display to the user includes:
displaying on a browser associated with the user:
a pop-up window that incorporates the content on the second website; and
a window displaying the content on the first website.

36. The method of claim 30, wherein the content on the second website is accessed by the user selecting a hyperlink provided within the webpage displaying the content on the first website.

37. The method of claim 30, wherein the content on the second website is displayed by the first webpage to provide a branded appearance.

38. The method of claim 37, wherein the branded appearance comprises at least one of a logo and banner that is representative of the first entity.

40. The method of claim 30, wherein the processing device comprises a web-enabled device.

41. The method of claim 40, wherein the web-enabled device comprises at least one of a personal computer, a notebook computer, a cellular telephone, a smartphone, and a personal digital assistant (PDA).

42. A user authentication system, comprising:
a memory; and
a processor disposed in communication with the memory and configured to issue processing instructions stored in the memory to:
receive authentication information of a user at a first website corresponding to a first entity;
validate the authentication information received at the first website, wherein upon validation of the authentication information, the user is provided access to content on the first website;
generate, from the first website, an out-of-band message for transmission to a second website corresponding to a second entity, wherein the out-of-band message includes an indication of the validation of the authentication information corresponding to the user; and
send content on the second website for display to the user based on the second website receiving the indication.

43. A processor-readable tangible medium storing processor-issuable user authentication instructions to:
receive authentication information of a user at a first website corresponding to a first entity;
validate the authentication information received at the first website, wherein upon validation of the authentication information, the user is provided access to content on the first website;
generate, from the first website, an out-of-band message for transmission to a second website corresponding to a second entity, wherein the out-of-band message includes an indication of the validation of the authentication information corresponding to the user; and
send content on the second website for display to the user based on the second website receiving the indication.

44. A user authentication processor-implemented method to transform first authentication information at a first entity to second authentication information at a second entity, comprising:
obtaining authentication information of a user corresponding to a first website corresponding to a first entity;
validating the authentication information, wherein upon validation of the authentication information, the user is provided access to content on the first website; and
generating an out-of-band message for transmission to a second website corresponding to a second entity, wherein the out-of-band message includes an indication of the validation of the authentication information corresponding to the user,
wherein content on the second website is sent for display to the user based on the second website receiving the indication.

45. A user authentication system, comprising:
a memory; and
a processor disposed in communication with the memory and configured to issue processing instructions stored in the memory to:
send, via a processing device, authentication information of a user to a first website corresponding to a first entity;
validate the authentication information received at the first website, wherein upon validation of the authentication information, the user is provided access to content on the first website;
send an out-of-band message from the first website to a second website corresponding to a second entity, wherein the out-of-band message includes an indication of the validation of the authentication information corresponding to the user; and
send content on the second website for display to the user based on the second website receiving the indication.

46. A processor-readable tangible medium storing processor-issuable user authentication instructions to:
send, via a processing device, authentication information of a user to a first website corresponding to a first entity;
validate the authentication information received at the first website, wherein upon validation of the authentication information, the user is provided access to content on the first website;
send an out-of-band message from the first website to a second website corresponding to a second entity, wherein the out-of-band message includes an indication of the validation of the authentication information corresponding to the user; and
send content on the second website for display to the user based on the second website receiving the indication.
